(19) United States
(12) Patent Application Publication
(10) Pub. No.: US 2021/0390458 A1
(43) Pub. Date: Dec. 16, 2021

(54) DATA ANALYTICS METHODS FOR SPATIAL DATA, AND RELATED SYSTEMS AND DEVICES

(71) Applicant: DataRobot, Inc., Boston, MA (US)

(72) Inventors: David Blumstein, Acton, MA (US); Lingjun Kang, Fairfax, VA (US); Andrey Mukomolov, Munich (DE); Joseph O'Hallaron, Denver, CO (US); Eric Reyes, Boston, MA (US); Rohit Sharma, Copenhagen (DK); Kevin Stofan, Saint Petersburg, FL (US); Pavel Tyslacki, Minsk (BY)

(21) Appl. No.: 17/348,493

(22) Filed: Jun. 15, 2021

Related U.S. Application Data
(60) Provisional application No. 63/039,217, filed on Jun. 15, 2020.

(51) Int. Cl. G06N 20/00; G06F 16/29; G06F 16/28

(52) U.S. Cl. CPC G06N 20/00; G06F 16/288; G06F 16/29

(57) ABSTRACT

Automated spatial feature engineering techniques may include (1) automatically deriving new features (e.g., spatial lags) based on spatial relationships between or among observations, (2) using parameter optimization techniques to optimize parameters of the spatial feature engineering process (e.g., parameters relating to the size of spatial neighborhoods and/or to the orders of spatial lags), (3) automatically deriving new spatial features representing geometric properties and/or spatial statistics associated with individual spatial observations, (4) determining the feature importance of location features, and/or (5) automatically partitioning spatial datasets such that spatial leakage is reduced, which generally leads to the development of more accurate spatial models. Such techniques may involve joint treatment of distinct location coordinate features as a single location feature for purposes of determining feature importance.

### CROSS-REFERENCE TO RELATED APPLICATIONS

This application claims priority to and benefit of U.S. Provisional Patent Application No. 63/039,217, titled “Data Analytics Methods For Spatial Data, And Related Systems And Devices” and filed under Attorney Docket No. DRB-017PR on Jun. 15, 2020, which is hereby incorporated by reference herein in its entirety.

The subject matter of this application is related to the subject matter of International Patent Application No. PCT/US2021/018404, titled “Automated Data Analytics Methods for Non-Tabular Data, and Related Systems and Apparatus” and filed under Attorney Docket No. DRB-013WO on Feb. 17, 2021, which is hereby incorporated by reference herein in its entirety.

### TECHNICAL FIELD

The present disclosure generally relates to machine learning and data analytics. Portions of the disclosure relate specifically to the use of automated machine learning techniques to develop and deploy data analytics tools that operate on spatial data alone or in combination with non-spatial data.

### BACKGROUND

Data analytics tools are used to guide decision-making and/or to control systems in a wide variety of fields and industries, e.g., security; transportation; fraud detection; risk assessment and management; supply chain logistics; development and discovery of pharmaceuticals and diagnostic techniques; and energy management. Historically, the processes used to develop data analytics tools suitable for carrying out specific data analytics tasks generally have been expensive and time-consuming, and often have required the expertise of highly-trained data scientists. Such processes generally includes steps of data collection, data preparation, feature engineering, model generation, and/or model deployment.

“Automated machine learning” technology may be used to automate significant portions of the above-described process of developing data analytics tools. In recent years, advances in automated machine learning technology have substantially lowered the barriers to the development of certain types of data analytics tools, particularly those that operate on time-series data, structured and unstructured textual data, categorical data, and numerical data.

### SUMMARY

Data analytics techniques for spatial data (alone or in combination with non-spatial data) are disclosed.

According to an aspect of the present disclosure, an automated, spatially-aware data analytics method includes: extracting location data from spatial data, the spatial data representing a plurality of spatial objects, the extracted location data indicating one or more sets of coordinates of one or more locations associated with each of the spatial objects; generating a first dataset including a plurality of spatial observations representing the respective plurality of spatial objects, wherein each spatial observation includes (1) a respective value of a location feature indicating a set of coordinates of a representative location of the spatial object corresponding to the spatial observation, and (2) respective values of one or more other features; performing one or more feature engineering tasks, feature selection tasks, and or data partitioning tasks on the first dataset based, at least in part, on spatial relationships between the location features of respective pairs of the spatial observations, thereby generating a second dataset; and training one or more machine learning models by performing one or more machine learning processes on the second dataset.

Other embodiments of this aspect include corresponding computer systems, apparatus, and computer programs recorded on one or more computer storage devices, each configured to perform the actions of the method. A system of one or more computers can be configured to perform particular actions by virtue of having software, firmware, hardware, or a combination of them installed on the system (e.g., instructions stored in one or more storage devices) that in operation causes or cause the system to perform the actions. One or more computer programs can be configured to perform particular actions by virtue of including instructions that, when executed by data processing apparatus, cause the apparatus to perform the actions.

In some embodiments, the spatial data are encoded in a vector format, a native geospatial format, a well-known text (WKT) format, or a well-known binary (WKB) format. In some embodiments, the spatial data are encoded in a raster format. In some embodiments, for each of the spatial objects, the one or more locations associated with the respective spatial object include one or more locations of one or more geometric elements of the respective spatial object. In some embodiments, the one or more geometric elements of the respective spatial object include one or more points, lines, curves, and/or polygons of the respective spatial object.

In some embodiments, for each of the spatial objects, the representative location of the respective spatial object is a location of a central tendency of the respective spatial object. In some embodiments, the actions of the method further include, for each of the spatial objects, determining the location of the central tendency of the spatial object based, at least in part, on the one or more sets of coordinates of the one or more locations associated with the respective spatial object. In some embodiments, the central tendency of the respective spatial object includes a mean center or a median center of the respective spatial object.

In some embodiments, performing the one or more feature engineering tasks, feature selection tasks, and/or data partitioning tasks includes spatially partitioning the plurality of spatial observations based on spatial relationships between the location features of respective pairs of the spatial observations. In some embodiments, spatially partitioning the plurality of spatial observations includes: performing spatial autocorrelation analysis on the spatial observations; based on the spatial autocorrelation analysis, determining a distance at a neighborhood effect for the plurality of spatial observations satisfies one or more neighborhood effect criteria; based on the distance, determining one or more characteristics of a spatial block for tessellation of a spatial region over which the spatial observations are dispersed; generating a tessellation of the spatial region, the tessellation including a plurality of instances of the spatial block, wherein each of the spatial observations is associated with the respective instance of the spatial block in which the coordinates of the location feature of the spatial observation are located; and partitioning the spatial observations among a plurality of data partitions, wherein the respective data partition to which each of the spatial observations is assigned is determined based on which instance of the spatial block is associated with the respective spatial observation.

In some embodiments, the actions of the method further include: determining whether a distribution of the spatial observations among the data partitions satisfies one or more distribution criteria; and if the distribution of the spatial observations does not satisfy the one or more distribution criteria, repartitioning the spatial observations among the plurality of data partitions. In some embodiments, the actions of the method further include: determining whether a distribution of the spatial observations among the data partitions satisfies one or more distribution criteria; and if the distribution of the spatial observations does not satisfy the one or more distribution criteria, adjusting one or more characteristics of the spatial block, thereby generating an adjusted spatial block, generating an adjusted tessellation of the spatial region including a plurality of instances of the adjusted spatial block, and repartitioning the spatial observations among the plurality of data partitions based on the respective instances of the adjusted spatial blocks with which the spatial observations are associated.

In some embodiments, the actions of the method further include: generating a training dataset including the spatial observations assigned to a first subset of the data partitions; and generating a testing dataset including the spatial observations assigned to a second subset of the data partitions. In some embodiments, training the one or more machine learning models includes training a first machine learning model by performing a first machine learning process on the training dataset. In some embodiments, the actions of the method further include testing the first machine learning model on the testing dataset.

In some embodiments, performing the one or more feature engineering tasks, feature selection tasks, and/or data partitioning tasks includes assessing a feature importance of the location feature for a first model included in the one or more machine learning models. In some embodiments, assessing the feature importance of the location feature for the first model includes: obtaining a test dataset including a plurality of test observations representing a respective plurality of spatial objects, wherein each test observation includes (1) a respective value of the location feature indicating a set of coordinates of a representative location of the spatial object corresponding to the test observation, (2) respective values of one or more other features, and (3) a respective value of a target variable; determining a first score characterizing a performance of the first model when tested on the test dataset; permuting the values of the location feature of the test observations across the test observations, thereby generating a retest dataset; determining a second score characterizing a performance of the first model when tested on the retest dataset; and determining a third score indicating a feature importance of the location feature based on the first and second scores.

In some embodiments, the first score represents an accuracy value, positive predictive value, negative predictive value, sensitivity, specificity, F1 score, logarithmic loss, Gini coefficient, concordant/discordant ratio, root mean squared error, root mean squared logarithmic error, R-Squared value, or adjusted R-Squared value of the first model for the test dataset. In some embodiments, determining the third score includes determining a difference between the first score and the second score. In some embodiments, the actions of the method further include performing at least one of the feature engineering tasks based, at least in part, on the third score indicating the feature importance of the location feature. In some embodiments, the actions of the method further include performing at least one of the feature selection tasks based, at least in part, on the third score indicating the feature importance of the location feature. In some embodiments, the actions of the method further include controlling an allocation of computational resources to the training of the machine learning models based, at least in part, on the third score indicating the feature importance of the location feature.

In some embodiments, the actions of the method further include extracting geometric data from the spatial data, the extracted geometric data characterizing one or more geometric elements of each of the spatial objects. In some embodiments, performing the one or more feature engineering tasks, feature selection tasks, and/or data partitioning tasks includes, for each of the spatial observations, deriving a respective value of a solitary spatial feature based on a portion of the extracted geometric data characterizing the geometric elements of the spatial object represented by the spatial observation. In some embodiments, the respective value of the solitary spatial feature of a particular spatial observation indicates a length, area, shape, or direction of the spatial object represented by the particular spatial observation. In some embodiments, the respective value of the solitary spatial feature of a particular spatial observations indicates a length, area, shape, or direction of a geometric element of the spatial object represented by the particular spatial observation. In some embodiments, the respective value of the solitary spatial feature of a particular spatial observation indicates a standard distance or a standard deviational ellipse of the spatial object represented by the particular spatial observation.

In some embodiments, performing the one or more feature engineering tasks, feature selection tasks, and/or data partitioning tasks includes: deriving a plurality of values of a relational spatial feature based on pairwise spatial relationships between the spatial observations; and inserting the values of the relational spatial feature into the respective spatial observations, thereby generating the second dataset. In some embodiments, deriving the values of the relational spatial feature includes: for each pair of the spatial observations, determining a respective pairwise distance between the pair of spatial observations based on the values of the location features of the pair of spatial observations; for each of the spatial observations, identifying a set of neighboring observations among the plurality of spatial observations by applying a neighborhood function to the pairwise distances associated with the respective spatial observation; and for each of the spatial observations, determining the respective value of the relational spatial feature based on values of one or more features of the neighboring observations of the respective spatial observation. In some embodiments, the pairwise distance between the pair of spatial observations is a function of the values of the location features of the pair of spatial observations. In some embodiments, the function corresponds to a particular type of spatial relationship. In some embodiments, the set of neighboring observations for at least one of the spatial observations is empty. In some embodiments, the relational spatial feature includes a spatially lagged variable, a local indicator of spatial autocorrelation, an indication of spatial cluster membership, and/or a significance score. In some embodiments, the respective value of the relational spatial feature is further based on the pairwise distances between the respective spatial observation and the neighboring observations of the respective spatial observation.

According to another aspect of the present disclosure, an automated, spatially-aware data analytics method includes: identifying a plurality of spatial objects represented by spatial data; extracting one or more spatial attributes of each of the spatial objects from the spatial data; determining coordinates of a representative location of each of the spatial objects based on the extracted spatial attributes; generating a first dataset including a plurality of spatial observation corresponding to the plurality of spatial objects, wherein each spatial observation includes the coordinates of the representative location of the corresponding spatial object as a value of a location feature; performing one or more feature engineering tasks, feature selection tasks, and/or data partitioning tasks on the first dataset based, at least in part, on spatial relationships between the location features of respective pairs of the spatial observations, thereby generating a second dataset; and training one or more machine learning models by performing one or more machine learning processes on the second dataset.

Other embodiments of this aspect include corresponding computer systems, apparatus, and computer programs recorded on one or more computer storage devices, each configured to perform the actions of the method. A system of one or more computers can be configured to perform particular actions by virtue of having software, firmware, hardware, or a combination of them installed on the system (e.g., instructions stored in one or more storage devices) that in operation causes or cause the system to perform the actions. One or more computer programs can be configured to perform particular actions by virtue of including instructions that, when executed by data processing apparatus, cause the apparatus to perform the actions.

In some embodiments, the spatial data are encoded in a vector format, a native geospatial format, a well-known text (WKT) format, or a well-known binary (WKB) format. In some embodiments, the spatial data are encoded in a raster format. In some embodiments, for each of the spatial objects, the one or more spatial attributes of the respective spatial object include one or more locations of one or more geometric elements of the respective spatial object. In some embodiments, for each of the spatial objects, the representative location of the respective spatial object is a location of a central tendency of the respective spatial object.

According to another aspect of the present disclosure, an automated, spatially-aware data partitioning method includes: obtaining a dataset including a plurality of spatial observations, wherein each spatial observation includes (1) a respective value of a location feature indicating a set of coordinates of a representative location of a respective spatial object, (2) respective values of one or more other features, and (3) a respective value of a target variable; performing spatial autocorrelation analysis on the values of the target variable of the spatial observations with respect to the coordinates of the location features of the spatial observations; based on the spatial autocorrelation analysis, determining a distance at which a neighborhood effect for the plurality of spatial observations satisfies one or more neighborhood effect criteria; based on the distance, determining one or more characteristics of a spatial block for tessellation of a spatial region over which the spatial observations are dispersed; generating a tessellation of the spatial region, the tessellation including a plurality of instances of the spatial block, wherein each of the spatial observations is associated with the respective instance of the spatial block in which the coordinates of the location feature of the spatial observation are located; and partitioning the spatial observations among a plurality of data partitions, wherein the respective data partition to which each of the spatial observations is assigned is determined based on which instance of the spatial block is associated with the respective spatial observation.

Other embodiments of this aspect include corresponding computer systems, apparatus, and computer programs recorded on one or more computer storage devices, each configured to perform the actions of the method. A system of one or more computers can be configured to perform particular actions by virtue of having software, firmware, hardware, or a combination of them installed on the system (e.g., instructions stored in one or more storage devices) that in operation causes or cause the system to perform the actions. One or more computer programs can be configured to perform particular actions by virtue of including instructions that, when executed by data processing apparatus, cause the apparatus to perform the actions.

In some embodiments, performing the spatial autocorrelation analysis includes calculating a plurality of values of an indicator of spatial autocorrelation corresponding to a respective plurality of spatial lags. In some embodiments, the distance at which the neighborhood effect satisfies the neighborhood effect criteria is a particular one of the spatial lags for which the respective value of the indicator of spatial autocorrelation is zero, is less than a threshold value, or is substantially equal to an asymptotic minimum value. In some embodiments, a shape of the spatial block is a square or a hexagon. In some embodiments, determining the characteristics of the spatial block includes determining a size of the spatial block based on the distance at which the neighborhood effect satisfies the neighborhood effect criteria.

In some embodiments, the actions of the method further include determining whether a distribution of the spatial observations among the data partitions satisfies one or more distribution criteria; and if the distribution of the spatial observations does not satisfy the one or more distribution criteria, repartitioning the spatial observations among the plurality of data partitions. In some embodiments, the actions of the method further include determining whether a distribution of the spatial observations among the data partitions satisfies one or more distribution criteria; and if the distribution of the spatial observations does not satisfy the one or more distribution criteria, adjusting one or more characteristics of the spatial block, thereby generating an adjusted spatial block, generating an adjusted tessellation of the spatial region including a plurality of instances of the adjusted spatial block, and repartitioning the spatial observations among the plurality of data partitions based on the respective instances of the adjusted spatial blocks with which the spatial observations are associated. In some embodiments, adjusting one or more characteristics of the spatial block includes changing a shape of the spatial block and/or decreasing a size of the spatial block.

In some embodiments, the actions of the method further include generating a training dataset including the spatial observations assigned to a first subset of the data partitions; and generating a testing dataset including the spatial observations assigned to a second subset of the data partitions. In some embodiments, training the one or more machine learning models includes training a first machine learning model by performing a first machine learning process on the training dataset. In some embodiments, the actions of the method further include testing the first machine learning model on the testing dataset.

According to another aspect of the present disclosure, a spatially-aware feature importance assessment method includes: obtaining a trained machine learning model and a first dataset including a plurality of spatial observations representing a respective plurality of spatial objects, wherein each spatial observation includes (1) a respective value of a location feature indicating a set of coordinates of a representative location of the spatial object corresponding to the spatial observation, (2) respective values of one or more other features, and (3) a respective value of a target variable; determining a first score characterizing a performance of the trained model when tested on the first dataset; permuting the values of the location feature across the spatial observations, thereby generating a second dataset; determining a second score characterizing a performance of the first model when tested on the second dataset; and determining a third score indicating a feature importance of the location feature based on the first and second scores.

Other embodiments of this aspect include corresponding computer systems, apparatus, and computer programs recorded on one or more computer storage devices, each configured to perform the actions of the method. A system of one or more computers can be configured to perform particular actions by virtue of having software, firmware, hardware, or a combination of them installed on the system (e.g., instructions stored in one or more storage devices) that in operation causes or cause the system to perform the actions. One or more computer programs can be configured to perform particular actions by virtue of including instructions that, when executed by data processing apparatus, cause the apparatus to perform the actions.

In some embodiments, the first score represents an accuracy value, positive predictive value, negative predictive value, sensitivity, specificity, F1 score, logarithmic loss, Gini coefficient, concordant/discordant ratio, root mean squared error, root mean squared logarithmic error, R-Squared value, or adjusted R-Squared value of the trained model for the first dataset. In some embodiments, determining the third score includes determining a difference between the first score and the second score.

In some embodiments, the actions of the method further include performing a feature engineering task based, at least in part, on the third score indicating the feature importance of the location feature. In some embodiments, the actions of the method further include performing a feature selection task based, at least in part, on the third score indicating the feature importance of the location feature. In some embodiments, the actions of the method further include controlling an allocation of computational resources to training of one or more other machine learning models based, at least in part, on the third score indicating the feature importance of the location feature.

According to another aspect of the present disclosure, an automated, spatially-aware feature engineering method includes: extracting geometric data from spatial data, the spatial data representing a plurality of spatial objects, the extracted geometric data characterizing one or more geometric elements of each of the spatial objects; extracting location data from the spatial data, the extracted location data indicating one or more sets of coordinates of one or more locations associated with each of the spatial objects; generating a dataset including a plurality of spatial observations representing the respective plurality of spatial objects, wherein each spatial observation includes (1) a respective value of a location feature indicating a set of coordinates of a representative location of the spatial object corresponding to the spatial observation, and (2) respective values of one or more other features; for each of the spatial observations, deriving respective values of one or more solitary spatial features based on a portion of the extracted geometric data characterizing the geometric elements of the spatial object represented by the spatial observation, and adding the values of the one or more solitary spatial features to the dataset; and training one or more machine learning models by performing one or more machine learning processes on the dataset.

Other embodiments of this aspect include corresponding computer systems, apparatus, and computer programs recorded on one or more computer storage devices, each configured to perform the actions of the method. A system of one or more computers can be configured to perform particular actions by virtue of having software, firmware, hardware, or a combination of them installed on the system (e.g., instructions stored in one or more storage devices) that in operation causes or cause the system to perform the actions. One or more computer programs can be configured to perform particular actions by virtue of including instructions that, when executed by data processing apparatus, cause the apparatus to perform the actions.

In some embodiments, the one or more solitary spatial features include a particular feature, wherein the respective value of the particular feature of a particular spatial observation indicates a length, area, shape, or direction of the spatial object represented by the particular spatial observation. In some embodiments, the one or more solitary spatial features include a particular feature, wherein the respective value of the particular feature of a particular spatial observation indicates a length, area, shape, or direction a geometric element of the spatial object represented by the particular spatial observation. In some embodiments, the one or more solitary spatial features include a particular feature, wherein the respective value of the particular feature of a particular spatial observation indicates a standard distance or a standard deviational ellipse of the spatial object represented by the particular spatial observation.

According to another aspect of the present disclosure, an automated, spatially-aware feature engineering method includes: extracting location data from spatial data, the spatial data representing a plurality of spatial objects, the extracted location data indicating one or more sets of coordinates of one or more locations associated with each of the spatial objects; generating a dataset including a plurality of spatial observations representing the respective plurality of spatial objects, wherein each spatial observation includes (1) a respective value of a location feature indicating a set of coordinates of a representative location of the spatial object corresponding to the spatial observation, and (2) respective values of one or more other features; deriving a plurality of values of a relational spatial feature based on pairwise spatial relationships between the spatial observations; inserting the values of the relational spatial feature into the respective spatial observations; and training one or more machine learning models by performing one or more machine learning processes on the dataset.

Other embodiments of this aspect include corresponding computer systems, apparatus, and computer programs recorded on one or more computer storage devices, each configured to perform the actions of the method. A system of one or more computers can be configured to perform particular actions by virtue of having software, firmware, hardware, or a combination of them installed on the system (e.g., instructions stored in one or more storage devices) that in operation causes or cause the system to perform the actions. One or more computer programs can be configured to perform particular actions by virtue of including instructions that, when executed by data processing apparatus, cause the apparatus to perform the actions.

In some embodiments, deriving the values of the relational spatial feature includes: for each pair of the spatial observations, determining a respective pairwise distance between the pair of spatial observations based on the values of the location features of the pair of spatial observations; for each of the spatial observations, identifying a set of neighboring observations among the plurality of spatial observations by applying a neighborhood function to the pairwise distances associated with the respective spatial observation; and for each of the spatial observations, determining the respective value of the relational spatial feature based on values of one or more features of the neighboring observations of the respective spatial observation.

In some embodiments, the pairwise distance between the pair of spatial observations is a function of the values of the location features of the pair of spatial observations. In some embodiments, the function corresponds to a particular type of spatial relationship. In some embodiments, the set of neighboring observations for at least one of the spatial observations is empty. In some embodiments, the relational spatial feature includes a spatially lagged variable, a local indicator of spatial autocorrelation, an indication of spatial cluster membership, and/or a significance score. In some embodiments, the respective value of the relational spatial feature is further based on the pairwise distances between the respective spatial observation and the neighboring observations of the respective spatial observation.

According to another aspect of the present disclosure, an automated, spatially-aware data analytics method includes: extracting location data from spatial data, the spatial data representing a plurality of spatial objects, the extracted location data indicating one or more sets of coordinates of one or more locations associated with each of the spatial objects; generating a first dataset including a plurality of spatial observations representing the respective plurality of spatial objects, wherein each spatial observation includes (1) a location feature indicating a set of coordinates of a representative location of the spatial object corresponding to the spatial observation, and (2) respective values of one or more other features; performing one or more feature engineering tasks on the first dataset based, at least in part, on spatial relationships between the location features of respective pairs of the spatial observations, thereby generating a second dataset including one or more engineered spatial features; and determining a value of a data analytics target based, at least in part, on values of the engineered spatial features, wherein the determining is performed by a trained machine learning model.

Other embodiments of this aspect include corresponding computer systems, apparatus, and computer programs recorded on one or more computer storage devices, each configured to perform the actions of the method. A system of one or more computers can be configured to perform particular actions by virtue of having software, firmware, hardware, or a combination of them installed on the system (e.g., instructions stored in one or more storage devices) that in operation causes or cause the system to perform the actions. One or more computer programs can be configured to perform particular actions by virtue of including instructions that, when executed by data processing apparatus, cause the apparatus to perform the actions.

In some embodiments, the spatial data are encoded in a vector format, a native geospatial format, a well-known text (WKT) format, or a well-known binary (WKB) format. In some embodiments, the spatial data are encoded in a raster format. In some embodiments, for each of the spatial objects, the one or more locations associated with the respective spatial object include one or more locations of one or more geometric elements of the respective spatial object. In some embodiments, the one or more geometric elements of the respective spatial object include one or more points, lines, curves, and/or polygons of the respective spatial object.

In some embodiments, for each of the spatial objects, the representative location of the respective spatial object is a location of a central tendency of the respective spatial object. In some embodiments, the actions of the method further include, for each of the spatial objects, determining the location of the central tendency of the spatial object based, at least in part, on the one or more sets of coordinates of the one or more locations associated with the respective spatial object. In some embodiments, the central tendency of the respective spatial object includes a mean center or a median center of the respective spatial object.

In some embodiments, the actions of the method further include assessing a feature importance of the location feature for the trained model. In some embodiments, assessing the feature importance of the location feature for the trained model includes: obtaining a test dataset including a plurality of test observations representing a respective plurality of spatial objects, wherein each test observation includes (1) a respective value of the location feature indicating a set of coordinates of a representative location of the spatial object corresponding to the test observation, (2) respective values of one or more other features, and (3) a respective value of a target variable; determining a first score characterizing a performance of the trained model when tested on the test dataset; permuting the values of the location feature of the test observations across the test observations, thereby generating a retest dataset; determining a second score characterizing a performance of the trained model when tested on the retest dataset; and determining a third score indicating a feature importance of the location feature based on the first and second scores.

In some embodiments, the actions of the method further include extracting geometric data from the spatial data, the extracted geometric data characterizing one or more geometric elements of each of the spatial objects. In some embodiments, performing the one or more feature engineering tasks includes, for each of the spatial observations, deriving respective values of one or more solitary spatial features based on a portion of the extracted geometric data characterizing the geometric elements of the spatial object represented by the spatial observation; and the engineered spatial features include the one or more solitary spatial features.

In some embodiments, performing the one or more feature engineering tasks includes: deriving a plurality of values of a relational spatial feature based on pairwise spatial relationships between the spatial observations; and inserting the values of the relational spatial feature into the respective spatial observations, thereby generating the second dataset. In some embodiments, deriving the values of the relational spatial feature includes: for each pair of the spatial observations, determining a respective pairwise distance between the pair of spatial observations based on the values of the location features of the pair of spatial observations; for each of the spatial observations, identifying a set of neighboring observations among the plurality of spatial observations by applying a neighborhood function to the pairwise distances associated with the respective spatial observation; and for each of the spatial observations, determining the respective value of the relational spatial feature based on values of one or more features of the neighboring observations of the respective spatial observation.

According to another aspect of the present disclosure, an automated, spatially-aware data analytics method includes: identifying a plurality of spatial objects represented by spatial data; extracting one or more spatial attributes of each of the spatial objects from the spatial data; determining coordinates of a representative location of each of the spatial objects based on the extracted spatial attributes; generating a first dataset including a plurality of spatial observation corresponding to the plurality of spatial objects, wherein each spatial observation includes the coordinates of the representative location of the corresponding spatial object as a value of a location feature; performing one or more feature engineering tasks on the first dataset based, at least in part, on spatial relationships between the location features of respective pairs of the spatial observations, thereby generating a second dataset including one or more engineered spatial features; and determining a value of a data analytics target based, at least in part, on values of the engineered spatial features, wherein the determining is performed by a trained machine learning model.

Other embodiments of this aspect include corresponding computer systems, apparatus, and computer programs recorded on one or more computer storage devices, each configured to perform the actions of the method. A system of one or more computers can be configured to perform particular actions by virtue of having software, firmware, hardware, or a combination of them installed on the system (e.g., instructions stored in one or more storage devices) that in operation causes or cause the system to perform the actions. One or more computer programs can be configured to perform particular actions by virtue of including instructions that, when executed by data processing apparatus, cause the apparatus to perform the actions.

In some embodiments, the spatial data are encoded in a vector format, a native geospatial format, a well-known text (WKT) format, or a well-known binary (WKB) format. In some embodiments, the spatial data are encoded in a raster format. In some embodiments, for each of the spatial objects, the one or more spatial attributes of the respective spatial object include one or more locations of one or more geometric elements of the respective spatial object. In some embodiments, for each of the spatial objects, the representative location of the respective spatial object is a location of a central tendency of the respective spatial object.

According to another aspect of the present disclosure, an automated, spatially-aware feature engineering method includes obtaining a dataset including a plurality of spatial observations representing a respective plurality of spatial objects, wherein each spatial observation includes (1) a respective value of a location feature indicating a set of coordinates of a representative location of the spatial object corresponding to the spatial observation, (2) respective values of one or more other features, and (3) a respective value of a target variable. The method further includes, for each of the other features: (a) performing autocorrelation analysis on the values of the respective feature; (b) based on the autocorrelation analysis, determining whether the respective feature exhibits sufficient spatial dependency; and (c) if the respective feature exhibits sufficient spatial dependency: (d) determining initial values of one or more feature derivation hyperparameters; (e) deriving one or more relational spatial feature candidates based on the values of the feature derivation hyperparameters, pairwise spatial relationships between the spatial observations, and the values of the respective feature; (f) determining feature impact scores of the respective feature candidates; (g) determining whether one or more stopping criteria are met; (h) if the stopping criteria are not met, adjusting the values of one or more of the feature derivation hyperparameters and returning to step (e); and (i) if the stopping criteria are met, adding one or more versions of the feature candidates to a set of potential features; and selecting one or more feature candidates from the set of potential features and inserting the selected feature candidates into the dataset.

Other embodiments of this aspect include corresponding computer systems, apparatus, and computer programs recorded on one or more computer storage devices, each configured to perform the actions of the method. A system of one or more computers can be configured to perform particular actions by virtue of having software, firmware, hardware, or a combination of them installed on the system (e.g., instructions stored in one or more storage devices) that in operation causes or cause the system to perform the actions. One or more computer programs can be configured to perform particular actions by virtue of including instructions that, when executed by data processing apparatus, cause the apparatus to perform the actions.

The foregoing Summary is intended to assist the reader in understanding the present disclosure, and does not limit the scope of any of the claims.

### BRIEF DESCRIPTION OF THE DRAWINGS

The accompanying figures, which are included as part of the present specification, illustrate the presently preferred embodiments and together with the general description given above and the detailed description of the preferred embodiments given below serve to explain and teach the principles described herein.

FIG. 1 shows a block diagram of a model development system, according to some embodiments.

FIG. 2 shows a block diagram of a data preparation and feature engineering module, according to some embodiments.

FIG. 3 shows a flowchart of a spatial feature extraction method, according to some embodiments;

FIG. 4A shows a flowchart of a spatial data partitioning method, according to some embodiments.

FIG. 4B shows a visualization of the outcome of partitioning a spatial dataset using the spatial partitioning method of FIG. 4A, according to an example.

FIG. 5A shows a visualization of the result of permitting unbounded permutations of location coordinates on separate axes, according to an example.

FIG. 5B shows a flowchart of a method for determining the feature importance of a location feature, according to some embodiments.

FIG. 6A shows a block diagram of a spatial feature engineering module, according to some embodiments.

FIG. 6B shows a flowchart of a method for spatial feature engineering, according to some embodiments.

FIG. 6C shows a flowchart of another method for spatial feature engineering, according to some embodiments.

FIG. 7 shows a flowchart of a model development method, according to some embodiments.

FIG. 8 shows a block diagram of a model deployment system, according to some embodiments.

FIG. 9 shows a flowchart of a model deployment method, according to some embodiments.

FIG. 10 is a block diagram of an example computer system.

FIG. 11A shows a block diagram of an image processing model, according to some embodiments.

FIG. 11B shows a block diagram of a pre-trained image feature extraction model, according to some embodiments.

FIG. 11C shows a block diagram of a pre-trained, fine-tunable image processing model, according to some embodiments.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

### Terms

As used herein, “data analytics” may refer to the process of analyzing data (e.g., using machine learning models or techniques) to discover information, draw conclusions, and/or support decision-making. Species of data analytics can include descriptive analytics (e.g., processes for describing the information, trends, anomalies, etc. in a dataset), diagnostic analytics (e.g., processes for inferring why specific trends, patterns, anomalies, etc. are present in a dataset), predictive analytics (e.g., processes for predicting future events or outcomes), and prescriptive analytics (processes for determining or suggesting a course of action).

“Machine learning” generally refers to the application of certain techniques (e.g., pattern recognition and/or statistical inference techniques) by computer systems to perform specific tasks. Machine learning techniques (automated or otherwise) may be used to build data analytics models based on sample data (e.g., “training data”) and to validate the models using validation data (e.g., “testing data”). The sample and validation data may be organized as sets of records (e.g., “observations” or “data samples”), with each record indicating values of specified data fields (e.g., “independent variables,” “inputs,” “features,” or “predictors”) and corresponding values of other data fields (e.g., “dependent variables,” “outputs,” or “targets”). Machine learning techniques may be used to train models to infer the values of the outputs based on the values of the inputs. When presented with other data (e.g., “inference data”) similar to or related to the sample data, such models may accurately infer the unknown values of the target(s) of the inference dataset.

A feature of a data sample may be a measurable property of an entity (e.g., person, thing, event, activity, etc.) represented by or associated with the data sample. For example, a feature can be the price of an apartment. As a further example, a feature can be a shape extracted from an image of the apartment. In some cases, a feature of a data sample is a description of (or other information regarding) an entity represented by or associated with the data sample. A value of a feature may be a measurement of the corresponding property of an entity or an instance of information regarding an entity. In some cases, a value of a feature can indicate a missing value (e.g., no value). For instance, in the above example in which a feature is the price of an apartment, the value of the feature may be ‘NULL’, indicating that the price of the apartment is missing.

Features can also have data types. For instance, a feature can have a location data type, an image data type, a numerical data type, a text data type (e.g., a structured text data type or an unstructured (“free”) text data type), a categorical data type, or any other suitable data type. In general, a feature's data type is categorical if the set of values that can be assigned to the feature is finite.

As used herein, “spatial data” may refer to data relating to the location, shape, and/or geometry of one or more spatial objects. A “spatial object” may be an entity or thing that occupies space and/or has a location in a physical or virtual environment. In some cases, a spatial object may be represented by an image (e.g., photograph, rendering, etc.) of the object. In some cases, a spatial object may be represented by one or more geometric elements (e.g., points, lines, curves, and/or polygons), which may have locations within an environment (e.g., coordinates within a coordinate space corresponding to the environment).

As used herein, “spatial attribute” may refer to an attribute of a spatial object that relates to the object's location, shape, or geometry. Spatial objects or observations may also have “non-spatial attributes.” For example, a residential lot is a spatial object that that can have spatial attributes (e.g., location, dimensions, etc.) and non-spatial attributes (e.g., market value, owner of record, tax assessment, etc.). As used herein, “spatial feature” may refer to a feature that is based on (e.g., represents or depends on) a spatial attribute of a spatial object or a spatial relationship between or among spatial objects. As a special case, “location feature” may refer to a spatial feature that is based on a location of a spatial object. As used herein, “spatial observation” may refer to an observation that includes a representation of a spatial object, values of one or more spatial attributes of a spatial object, and/or values of one or more spatial features.

Spatial data may be encoded in vector format, raster format, or any other suitable format. In vector format, each spatial object is represented by one or more geometric elements. In this context, each point has a location (e.g., coordinates), and points also may have one or more other attributes. Each line (or curve) comprises an ordered, connected set of points. Each polygon comprises a connected set of lines that form a closed shape. In raster format, spatial objects are represented by values (e.g., pixel values) assigned to cells (e.g., pixels) arranged in a regular pattern (e.g., a grid or matrix). In this context, each cell represents a spatial region, and the value assigned to the cell applies to the represented spatial region.

Relationships between pairs of spatial objects within a set of spatial objects may be represented by a “weights matrix.” Some non-limiting examples of types of relationships between spatial objects include distance (e.g., the spatial distance between the spatial objects, calculated in accordance with any suitable distance metric), time (e.g., the travel time between the spatial objects, calculated in accordance with any suitable mode of travel or transportation), cost (e.g., the cost of moving something between the spatial objects, calculated in accordance with any suitable cost metric), etc. A weights matrix for a set of N spatial objects may be encoded as an N×N matrix of weights in which each of the N spatial objects corresponds to a matrix row and to matrix a column, and the value stored in each cell of the matrix represents the relationship between the spatial objects corresponding to that row and that column. In some cases, the row of values (“weights”) and/or the column of values corresponding to a spatial object may be used as feature(s) of the spatial object's observation. Including both the row and the column corresponding to a spatial object in the object's observation may be advantageous in cases where the relationship represented by the weights matrix can be asymmetric.

As used herein, “spatial lag” refers to a type of spatial feature that is based on a spatial object's relationship(s) to one or more other spatial objects. Some non-limiting examples of spatial lags include the average market value of all residential properties within 800 meters of a property P, the total number of workers employed in offices within walking distance of the location of a restaurant R, etc. More formally, the values of a spatial lagged feature F_{L} for a set of spatial objects generally can be determined by calculating the matrix product between a weights matrix W and a spatial objects vector y, where the non-zero elements of the weights matrix W define a neighbor structure, each element of the vector y represents the value of the feature F of the corresponding spatial object (e.g., the market value of a residential property represented by the spatial object), and the value of the spatial lagged feature F_{L} is a weighted function of the neighboring values for that feature:

F_{L}=g(wy)

F_{L}(i)=g(wy(i))=g(wᵢ₁y₁+Wᵢ₂y₂+ . . . +Wᵢₙyₙ)=g(Σⱼ₌₁ⁿWᵢⱼyⱼ),

where F_{L} is a first-order spatial lag, the weights Wᵢⱼ are the elements of the i-th row of the weights matrix W, each weight Wᵢⱼ is matched with corresponding element of the vector y, and g is an optional functional operator (e.g., the average). In other words, the value of a spatially lagged feature is a weighted function of the values of the feature observed at neighboring spatial objects. In addition, a spatial lag F_{L} of order m can be determined by calculating:

F_{L}^{m}=g(W^{m}y).

As used herein, “non-spatial data” may refer to any type of data other than spatial data, including but not limited to structured textual data, unstructured textual data, categorical data, and/or numerical data. As used herein, “non-spatial feature” may refer to a feature that is not based on (e.g., not calculated based on) a spatial attribute of a spatial object or a spatial relationship between or among spatial objects.

As used herein, “image data” may refer to a sequence of digital images (e.g., video), a set of digital images, a single digital image, and/or one or more portions of any of the foregoing. A digital image may include an organized set of picture elements (“pixels”). Digital images may be stored in computer-readable files. Any suitable format and type of digital image file may be used, including but not limited to raster formats (e.g., TIFF, JPEG, GIF, PNG, BMP, etc.), vector formats (e.g., CGM, SVG, etc.), compound formats (e.g., EPS, PDF, PostScript, etc.), and/or stereo formats (e.g., MPO, PNS, JPS, etc.).

As used herein, “non-image data” may refer to any type of data other than image data, including but not limited to structured textual data, unstructured textual data, categorical data, and/or numerical data. As used herein, “natural language data” may refer to speech signals representing natural language, text (e.g., unstructured text) representing natural language, and/or data derived therefrom. As used herein, “speech data” may refer to speech signals (e.g., audio signals) representing speech, text (e.g., unstructured text) representing speech, and/or data derived therefrom. As used herein, “auditory data” may refer to audio signals representing sound and/or data derived therefrom.

As used herein, “time-series data” may refer to data collected at different points in time. For example, in a time-series dataset, each data sample may include the values of one or more variables sampled at a particular time. In some embodiments, the times corresponding to the data samples are stored within the data samples (e.g., as variable values) or stored as metadata associated with the dataset. In some embodiments, the data samples within a time-series dataset are ordered chronologically. In some embodiments, the time intervals between successive data samples in a chronologically-ordered time-series dataset are substantially uniform.

Time-series data may be useful for tracking and inferring changes in the dataset over time. In some cases, a time-series data analytics model (or “time-series model”) may be trained and used to predict the values of a target Z at time t and optionally times t+1, . . . , t+i, given observations of Z at times before t and optionally observations of other predictor variables P at times before t. For time-series data analytics problems, the objective is generally to predict future values of the target(s) as a function of prior observations of all features, including the targets themselves.

Data (e.g., variables, features, etc.) having certain data types, including data of the numerical, categorical, or time-series data types, are generally organized in tables for processing by machine-learning tools. Data having such data types may be referred to collectively herein as “tabular data” (or “tabular variables,” “tabular features,” etc.). Data of other data types, including data of the image, textual (structured or unstructured), natural language, speech, auditory, or spatial data types, may be referred to collectively herein as “non-tabular data” (or “non-tabular variables,” “non-tabular features,” etc.).

As used herein, “data analytics model” may refer to any suitable model artifact generated by the process of using a machine learning algorithm to fit a model to a specific training dataset. The terms “data analytics model,” “machine learning model” and “machine learned model” are used interchangeably herein.

As used herein, the “development” of a machine learning model may refer to construction of the machine learning model. Machine learning models may be constructed by computers using training datasets. Thus, “development” of a machine learning model may include the training of the machine learning model using a training dataset. In some cases (generally referred to as “supervised learning”), a training dataset used to train a machine learning model can include known outcomes (e.g., labels or target values) for individual data samples in the training dataset. In other cases (generally referred to as “unsupervised learning”), a training dataset does not include known outcomes for individual data samples in the training dataset.

Following development, a machine learning model may be used to generate inferences with respect to “inference” datasets based on prior training. As used herein, the “deployment” of a machine learning model may refer to the use of a developed machine learning model to generate inferences about data other than the training data.

As used herein “feature impact score” may refer to a score (e.g., a value) that indicates the extent to which the values of a feature of a dataset are correlated with the values of the dataset's target variable. In contrast to “feature importance,” the “feature impact” metric is a statistical property of a dataset (in particular, a statistical property of the feature in question and the dataset's target variable) that can be calculated without reference to any data analytics model.

As used herein, a “modeling blueprint” (or “blueprint”) refers to a computer-executable set of preprocessing operations, model-building operations, and postprocessing operations to be performed to develop a model based on the input data. Blueprints may be generated “on-the-fly” based on any suitable information including, without limitation, the size of the user data, features types, feature distributions, etc. Blueprints may be capable of jointly using multiple (e.g., all) data types, thereby allowing the model to learn the associations between features of one type (e.g., spatial features), as well as between features of different types (e.g., spatial and non-spatial features).

### Motivation and Overview

As noted above, recent advances in automated machine learning technology have substantially lowered the barriers to the development of certain types of data analytics tools, particularly those that operate on time-series data, categorical data, and numerical data. However, improved automated machine learning technology is needed to facilitate the development of data analytics tools and models that operate on spatial data (alone or in combination with non-spatial data). Such technology may be referred to herein as “spatially-aware automated machine learning” tools or processes. There is also a need for data analytics tools that can accurately determine the spatial relationships between spatial objects, accurately determine the importance of spatial data relative to other types of data in the context of solving specific data analytics problems, partition spatial data into training datasets and validation datasets while minimizing leakage of spatial dependency structures, and/or automatically engineer spatial features. In addition, there is a need for interpretive tools that can explain how data analytics tools are interpreting spatial data (e.g., by accurately indicating the importance of spatial data to the inferences made or conclusions drawn by the tools).

Portions of the disclosure relate to automated spatial feature engineering techniques, e.g., (1) automatically deriving new features (e.g., spatial lags) based on spatial relationships between or among observations, (2) using parameter optimization techniques to optimize parameters of the spatial feature engineering process (e.g., parameters relating to the size of spatial neighborhoods and/or to the orders of spatial lags), and (3) automatically deriving new spatial features representing geometric properties and/or spatial statistics associated with individual spatial observations. Portions of the disclosure relate to techniques for determining the feature importance of location features. Such techniques may involve joint treatment of distinct location coordinate features as a single location feature for purposes of determining feature importance. Portions of the disclosure relate to techniques for automatically partitioning spatial datasets such that spatial leakage is reduced, which generally leads to the development of more accurate spatial models.

Using the techniques described herein, automated machine learning (ML) tools can automatically generate spatial machine learning models in minutes or hours. The performance (e.g., accuracy, computational efficiency, etc.) of such automatically-generated spatial ML models may be comparable or superior to the performance of models developed over many weeks or months by highly-trained teams of data scientists using conventional model-development techniques.

### Spatially-Aware Automated Machine Learning

Conventional techniques for developing data analytics models that analyze both spatial data and non-spatial data have significant shortcomings. In one approach, spatial data in raster format are analyzed using deep neural networks, additional data are analyzed using machine learning techniques, and then the results of the separate neural network and machine learning model are combined at a high-level to produce an output (e.g., analysis, prediction, etc.). This approach makes it difficult to recognize or exploit fine-grained relationships between the spatial data and the other data. In another approach, spatial data in vector format are converted into a tabular format in which each point's location is broken down into individual coordinates which are mapped to distinct numeric fields in the table (e.g., the x-coordinate, y-coordinate, and z-coordinate of a point in a 3D space are mapped to three distinct columns in the table), and additional data are mapped to other fields in the table. While this approach makes it possible to use machine learning algorithms to perform an integrated analysis of the points' coordinates and the other data, the results are generally unsatisfactory because the machine learning algorithms are not “spatially aware.” For example, because machine learning algorithms generally assume that distinct fields in the dataset are statistically independent, these algorithms are not aware of the spatial relationships between the fields representing the different coordinates of each point's location, and not aware of the spatial relationships between the locations of different spatial objects in the dataset.

The techniques described in this disclosure address the shortcomings of the above-described approaches by adding “spatial awareness” to machine learning tools that operate on spatial data (alone or in combination with non-spatial data). Such “spatial awareness” can be added to machine learning tools by (1) automatically extracting location information from spatial data representing a set of spatial objects, (2) automatically converting the extracted location information (e.g., coordinates of spatial objects) into values of a “location feature,” (3) automatically generating a dataset (e.g., table) of “spatial observations” representing the spatial objects, where each spatial observation includes the value of the location feature for the corresponding spatial object and optionally includes values of one or more additional spatial features and/or non-spatial features extracted from the spatial data or from other data relating to the spatial objects, (4) performing feature engineering tasks and/or data preparation tasks on the dataset using algorithms that recognize the value of a spatial object's location feature as a set of related coordinates rather than treating those coordinate values as independent numeric features, and (5) after performing the feature engineering and/or data preparation tasks on the dataset, applying automated machine learning techniques to the dataset to systematically and cost-effectively build one or more models that efficiently and accurately solve the analytics problem.

### Spatially-Aware Data Partitioning

Spatial data often exhibit properties (e.g., “spatial autocorrelation” or “spatial dependence”) that violate assumptions made in conventional statistical modeling processes, such as the assumption that distinct features are independent and identically distributed random variables. These properties of spatial data can interfere with the development of machine learning models. For example, when spatial autocorrelation (or spatial dependence) exists within a spatial dataset, conventional dataset partitioning techniques tend to be ineffective, because the same spatial dependence structures tend to be present in the training data and the testing data. In other words, conventional techniques for partitioning spatial data tend to cause a form of data leakage by carrying spatial dependency structures across data partitions. The inventors have recognized and appreciated that this form of data leakage (referred to herein as “spatial dependence structure leakage”) often arises from spatial objects that are close spatial neighbors being distributed across data partitions. The presence of this spatial dependency structure leakage generally results in overly optimistic validation and holdout results due to overfitting on the leaked spatial dependency structures.

Thus, there is a need for spatial data partitioning techniques that reduce spatial dependence structure leakage. The present disclosure describes a spatial data partitioning method that uses spatial autocorrelation analysis to determine the parameters of a spatial blocking scheme that, when applied to the spatial dataset, reduces (e.g., minimizes) cross-block placement of spatial dependence structures. Spatial observations from the spatial dataset are then partitioned at the block level, such that spatial dependence structure leakage is reduced (e.g., minimized).

### Spatially-Aware Feature Importance

Data analysis tools may use “feature importance” analysis to determine the significance of particular features to particular models (e.g., the extent to which a particular model relies on a particular feature to estimate or predict values of a target variable). Determining the “feature importance” of various features may involve permutation importance analysis. However, conventional data analysis tools do not accurately infer constraints (boundaries) on the locations of spatial objects when permuting the coordinates of the objects' location, and therefore do not limit the feature importance analysis to locations within the boundaries indicated by the dataset. This failure to adhere to the spatial boundaries of the dataset tends to artificially inflate the feature importance of location features, because the out-of-bounds locations tend to drag down the model's overall performance. Thus, there is a need for techniques for accurately estimating the importance of location information to spatial data analytics models. The present disclosure describes a spatially-aware method for estimating the importance of location features, whereby the sets of coordinates representing locations in a spatial dataset are jointly permuted, rather than permuting the individual coordinates independently. In this way, the spatially-aware method permutes the locations in the original dataset across the dataset's observations, rather than creating new combinations of coordinates representing new locations not present in the original dataset. When applied to spatial data analytics models, this spatially-aware method tends to more accurately estimate the importance of location features.

### Spatially-Aware Feature Engineering

In many fields of spatial data analytics, the performance of spatial models can be enhanced by expanding the underlying datasets to include derived spatial features. The present disclosure describes automated spatial feature engineering techniques that can be used to derive such spatial features from other spatial features, alone or in combination with non-spatial features (e.g., numeric features, categorical features, image features, etc.). For example, the techniques described herein may be used to derive “solitary spatial features” and/or “relational spatial features” from a dataset, as described in further detail below.

The universe (“space”) of relational spatial feature candidates for a spatial dataset can be immense, and deriving the values of even a small fraction of the relational spatial feature candidates for a dataset can require significant computational resources. In some embodiments, the feature engineering process used to derive relational spatial feature candidates may be controlled by feature engineering hyperparameters, and hyperparameter optimization techniques may be used to set the values of those hyperparameters, thereby guiding (e.g., optimizing) the process of automatically deriving and evaluating relational spatial feature candidates such that the process efficiently converges upon the most useful feature candidates.

### Relationship to Some Other Areas of Data Analytics and Machine Learning

The models (e.g., machine learning models) and techniques (e.g., modeling techniques, automation techniques, feature engineering techniques, data partitioning techniques, techniques for determining the importance of certain data relative to other data, techniques for interpreting the outputs of models and tools) described herein are generally described in the context of solving data analytics problems using both spatial data and non-spatial data. However, one of ordinary skill in the art will appreciate that these models and techniques are applicable to other tasks (e.g., optimization of parameters in non-spatial feature engineering tasks; natural language processing; speech processing, computer vision, audio processing; etc.).

### Model Development System

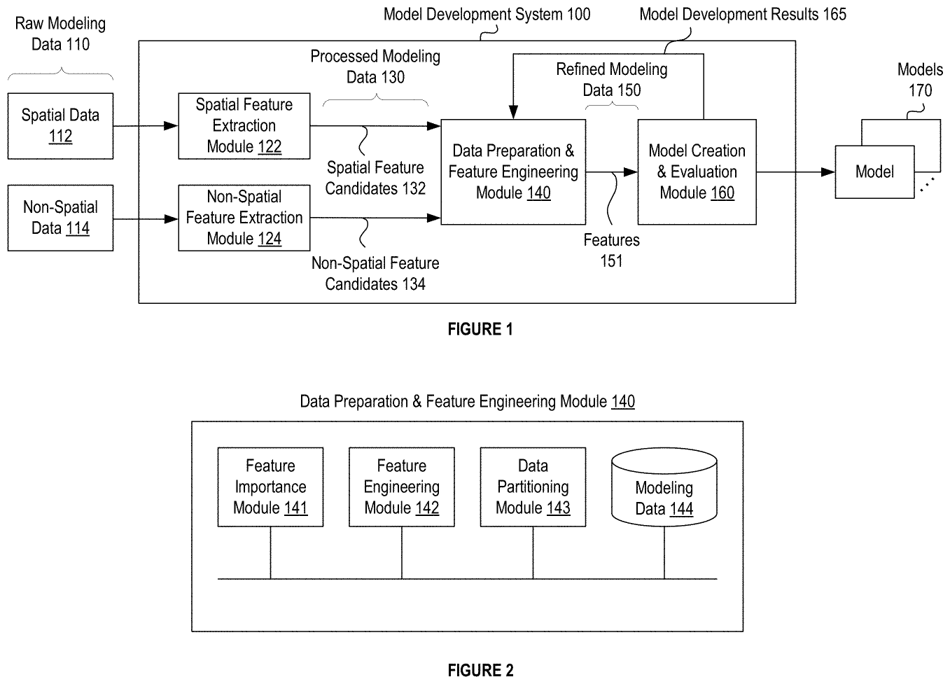

Referring to FIG. 1, a model development system 100 may include a spatial feature extraction module 122, a non-spatial feature extraction module 124, a data preparation and feature engineering module 140, and a model creation and evaluation module 160. In some embodiments, the model development system 100 receives raw modeling data 110 and uses the raw modeling data to develop (e.g., automatically develop) one or more models 170 (e.g., machine learning models, etc.) that solve a problem in a domain of data analytics. The raw modeling data 110 may include spatial data 112. Optionally, the raw modeling data 110 may also include non-spatial data 114. Some embodiments of the components and functions of the model development system 100 are described in further detail below.

In some embodiments, the spatial feature extraction module 122 performs spatial data pre-processing and spatial feature extraction on the spatial data 112, and provides the extracted features to the data preparation and feature engineering module 140 as spatial feature candidates 132 within a processed modeling dataset 130. The extracted features may include, for example, the locations and optionally other attributes of spatial objects represented by the spatial data 112, the locations and optionally other attributes of the geometric elements of the spatial objects, etc. In some embodiments, the spatial feature extraction module 122 stores the extracted coordinates of each spatial object as related values of a “location feature” rather than storing the coordinates as independent values of unrelated numeric features. Any suitable techniques may be used to extract spatial features from the spatial data 112, including (without limitation) the techniques described below.

In some embodiments, the extracted location feature values are referenced to a first frame of reference or coordinate system (e.g., global latitude and longitude), and the spatial feature extraction module 122 applies a transformation to the extracted location feature values to generate the spatial feature candidates 132, such that the locations of the spatial feature candidates 132 are referenced to a second frame of reference or coordinate system (e.g., an Eckert-VI projection, another equal-area pseudo-cylindrical map projection, etc.). Any suitable transformation, frame of reference, or coordinate system may be used. However, transforming location feature values from a latitude/longitude coordinate system to an equal-area pseudo-cylindrical map projection can enhance the accuracy of downstream analysis, because longitude is not a true ratio scale variable (at different latitudes, the same difference in longitude can represent significantly different distances).

In some embodiments, the spatial feature extraction module 122 may perform one or more of the operations described below with reference to “spatial feature extraction.”

Optionally, the model development system 100 may include a non-spatial feature extraction module 124, which may extract one or more non-spatial features from the raw modeling data 110. For example, the raw modeling data 110 may include image data, and the non-spatial feature extraction module 124 may include an image feature extraction module that performs image pre-processing and feature extraction on the image data, and provides the extracted features to the data preparation and feature engineering module 140 as image feature candidates within the processed modeling dataset 130.

The extracted features may include, for example, unmodified portions of the image data, low-level image features, mid-level image features, high-level image features, and/or highest level image features. Any suitable techniques may be used to extract the image feature candidates. In some embodiments, the image feature extraction module may perform image pre-processing and feature extraction using one or more image processing models. As described in further detail below, image processing models may include pre-trained image feature extraction models, pre-trained fine-tunable image processing models, or a blend of the foregoing. In some embodiments, the image feature extraction module may use a pre-trained image feature extraction model to extract image features from the image data. The image feature extraction model may be “pre-trained” in the sense that it has been trained to extract features suitable for performing a particular computer vision task (e.g., detecting cats in images), whereas the model development system 100 may be developing a model 170 that performs a distinct data analytics task (e.g., estimating the market value of a residential property based in part on images thereof).

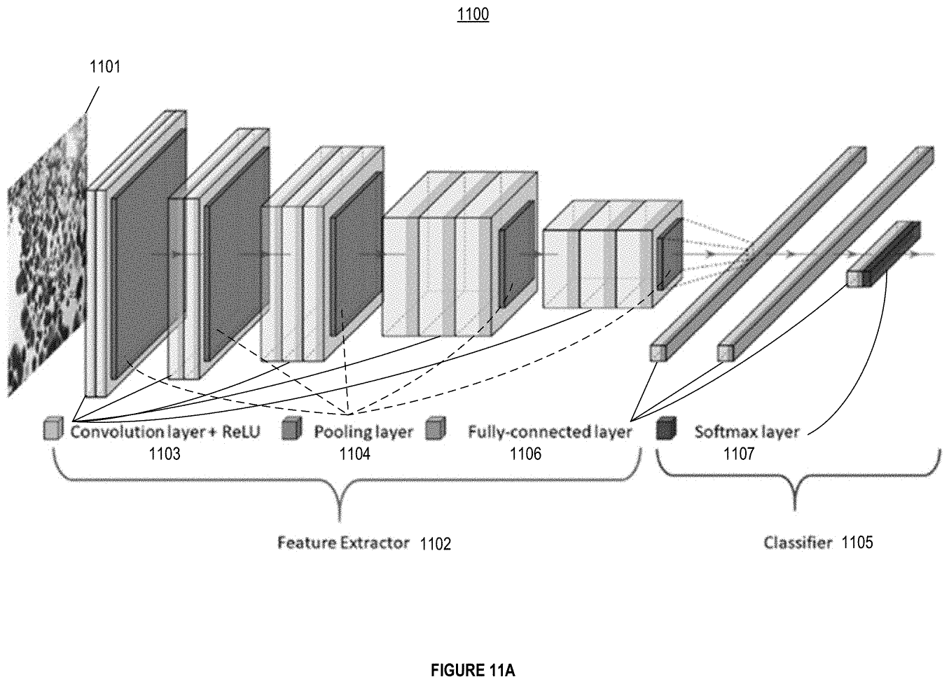

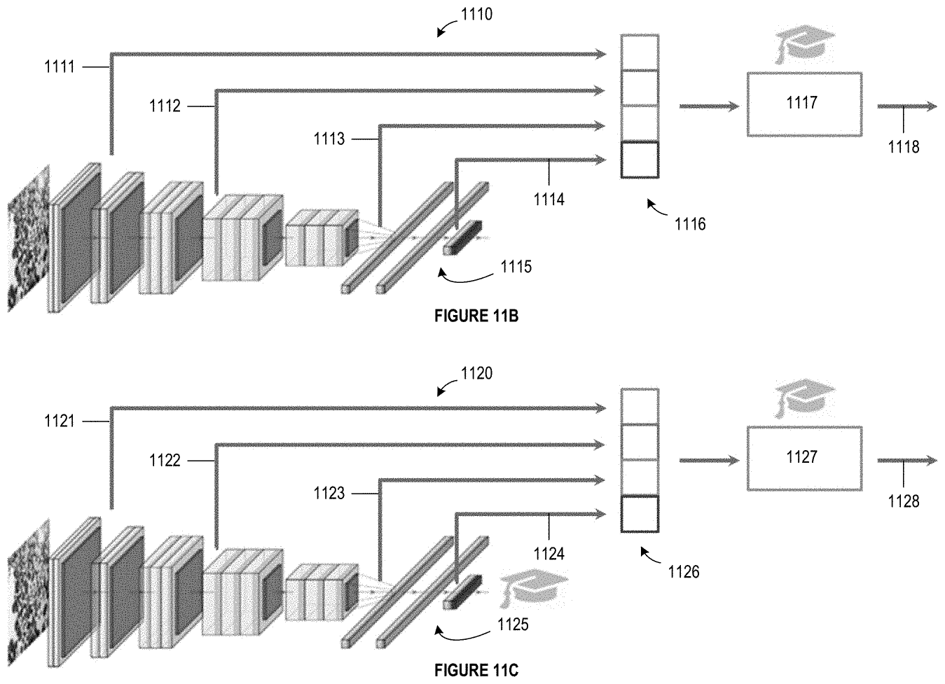

In some embodiments, the image feature extraction module uses a pre-trained, fine-tunable image processing model to extract image features from the image data. The fine-tunable image processing model may be “pre-trained” in the sense that it has been trained to extract features suitable for performing a particular computer vision task (e.g., detecting cats in images), whereas the model development system 100 may be developing a model 170 that performs a different data analytics task (e.g., estimating the value of a house based in part on images thereof). However, in contrast to the pre-trained image feature extraction model, one or more layers of the fine-tunable model's neural network may be tunable (trainable) to adapt the model's output to the data analytics task at hand. Referring to FIG. 11A, an image processing model may be or include a neural network 1100 (e.g., a convolutional neural network or “CNN”) trained to extract features (e.g., low-, mid-, high-, and/or highest-level features) from images 1101 and perform one or more computer vision tasks (e.g., image classification, localization, object detection, object segmentation, etc.) based on one or more of the extracted features. In the example of FIG. 11A, the upstream portion of the neural network 1100 functions as a feature extractor 1102, and the downstream portion of the neural network functions as a classifier 1105. More generally, the downstream portion of the neural network may be trained to perform data analytics operations other than classification. In the example of FIG. 11A, the feature extractor portion of the neural network 1100 includes a sequence of multi-layer blocks, each of which includes one or more convolution layers 1103 with rectified linear unit (ReLU) activation functions followed by a pooling layer 1104. Other suitable activation functions may be used. Each successive pooling layer 1104 outputs higher-level image features. In the example of FIG. 11A, the classifier portion of the neural network 1100 includes a sequence of fully connected layers 1106 followed by a Softmax layer 1107.

The neural network architecture shown in FIG. 11A is just one example of a neural network architecture that may be suitable for use in an image processing model. Any suitable neural network architecture may be used (e.g., VGG16, ResNet50, etc.).

In some embodiments, an image processing model may be configured as a pre-trained image feature extraction model. An example of a pre-trained image feature extraction model 1110 is shown in FIG. 11B. In the example of FIG. 11B, low-level image features 1111 are the outputs of the first pooling layer, mid-level image features 1112 are the outputs of the third pooling layer, and high-level image features 1113 are the outputs of the fifth pooling layer. In the example of FIG. 11B, the highest-level image features 1114 are the inputs to the final fully-connected layer. Other mappings of neural network layer outputs to image feature sets are possible. Each set of image features (1111-1114) may be a set of numeric values, and the individual sets of image feature may be concatenated to form an image feature vector 1116 of numeric values.

In the pre-trained image feature extraction model 1110, the layers of the upstream portion 1102 and downstream portion 1105 of the neural network may be pre-trained. Thus, when used in a model development system 100, a pre-trained image feature extraction model 1110 may extract (or “derive”) image feature values from image training data without any layers of the neural network being trained or tuned on that image training data. In other words, the pre-trained image feature extraction model 1110 may be configured such that no layer of model's neural network learns during the model development process carried out by the model development system 100. Rather, as shown in FIG. 11B, the image feature vector 1116 may be used an input feature of a data analytics model 1117, and the model development system 100 may train that data analytics model 1117 to perform a data analytics task (e.g., to provide an inference 1118) based (at least in part) on the image feature vector 1116.

In some embodiments, one or more (e.g., all) neural network layers that are only used to train the network (e.g., Batch Normalization layers) may be removed from neural networks that are used as (or included in) pre-trained image feature extraction models. As discussed above, pre-trained image feature extraction models may be configured such that they do not learn during the model development process carried out by the model development system 100. In such scenarios, network layers that are only useful for learning (e.g., for training or tuning the network) are unnecessary. Removing such layers can eliminate a significant amount of otherwise wasteful computation performed by the model 1110. In general, removing such layers may increase the speed of the neural network's inference operation by a factor of 2× to 2.5×, and can reduce the neural network's RAM usage by roughly the same amount.

In some embodiments, an image processing model may be configured as a pre-trained, fine-tunable image processing model. An example of a pre-trained, fine-tunable image processing model 1120 is shown in FIG. 11C. In the example of FIG. 11C, low-level image features 1121 are the outputs of the first pooling layer, mid-level image features 1122 are the outputs of the third pooling layer, and high-level image features 1123 are the outputs of the fifth pooling layer. In the example of FIG. 11C, the highest-level image features 1124 are the inputs to the final fully-connected layer. Other mappings of neural network layer outputs to image feature sets are possible. Each set of image features (1121-1124) may be a set of numeric values, and the individual sets of image feature may be concatenated to form an image feature vector 1126 of numeric values.

In the pre-trained, fine-tunable image processing model 1120, the layers of the upstream portion 1102 of the neural network may be pre-trained, but the layers of the downstream portion 1105 of the neural network may be tunable. Thus, when used in a model development system 100, a pre-trained, fine-tunable image processing model 1120 may extract (or “derive”) image feature values from image training data without any layers of the upstream portion 1102 of the neural network being trained or tuned on that image training data. However, during the model development process carried out by the model development system, the downstream portion 1105 of the model's neural network may be trained or tuned on the image training data, such that the highest-level image features 1124 produced by the image processing model 1120 are specifically adapted to the computer vision problem or data analytics problem that is being solved by the model development system 100. As shown in FIG. 11C, the image feature vector 1112 may be used an input feature of a data analytics model 1127, which may be trained to perform a data analytics task (e.g., trained to provide an inference 1128) based (at least in part) on the image feature vector 1126. Alternatively, if the dataset contains only image data, the downstream portion 1105 of the model's neural network may be trained or tuned to provide the inference 1128 directly, without using a separate data analytics model 1127.

In the example of FIG. 1, the spatial feature extraction module 122 and the non-spatial feature extraction module 124 are shown as separate modules. In some embodiments, the feature extraction modules (122, 124) may be integrated.

The data preparation and feature engineering module 140 may perform data preparation and/or feature engineering operations on the processed modeling data 130. The data preparation operations may include, for example, characterizing the input data. Characterizing the input data may include detecting missing observations, detecting missing variable values, and/or identifying outlying variable values. In some embodiments, characterizing the input data includes detecting duplicate portions of the modeling data 130 (e.g., observations, spatial objects, images, etc.). If duplicate portions of the modeling data 130 are detected, the model development system 100 may notify a user of the detected duplication.

Referring to FIG. 2, some embodiments of the data preparation and feature engineering module 140 may include a feature importance module 141, a feature engineering module 142, and/or a data partitioning module 143, each of which may be configured to operate on modeling data 144. In some embodiments, the operations performed by the data preparation and feature engineering module 140 transform the modeling data 144 from the processed modeling data 130 into refined modeling data 150.

In some embodiments, the feature importance module 141 determines the “feature importance” (sometimes referred to simply as the “importance”) of one or more features of the modeling data 144 (e.g., spatial feature candidates 132, other spatial features engineered from the processed modeling data 130, image feature candidates, other non-spatial feature candidates 134, and/or other engineered features) to a particular model. A candidate feature's “importance” to a model may indicate the extent to which the model relies on the feature (e.g., relative to other candidate features) to generate accurate estimates of a target variable's value. Any suitable techniques may be used to determine a feature's importance. In some embodiments, feature importance metrics determined by a feature importance module 141 may include, without limitation, univariate feature importance, feature impact, permutation importance, and SHapley Additive exPlanations (“SHAP”). These metrics and some embodiments of techniques for assessing (or “scoring”) the feature importance of various types of features according to these metrics are described below.

In some embodiments, the feature importance module 141 may determine univariate feature importance scores for one or more (e.g., all) the features of a dataset during the exploratory data analysis phase of the model development process. In some embodiments, the techniques described below (see, e.g., “Spatially-Aware Feature Importance”) may be used to determine the importance of spatial features. In some embodiments, permutation importance techniques are generally used to determine the importance of non-spatial features. In some embodiments, the feature importance techniques described below (see, e.g., “Image Feature Importance”) may be used to determine the importance of image features.

In general, the “univariate feature importance” of a feature F for a modeling problem P is an estimate of the correlation between the target of the modeling problem P and the feature F. Any suitable technique may be used to determine the univariate feature importance of tabular features.

In general, the “feature impact” (e.g., feature importance) of a feature F for a model M is an estimate of the extent to which the feature F contributes to the performance (e.g., accuracy) of the model M. The feature impact of a feature F may be “model-specific” or “model-dependent” in the sense that it may vary with respect to two different models M1 and M2 that solve the same modeling problem (e.g., using the same feature set).

In general, the feature impact of a non-tabular feature F for a trained model M may be determined by (1) using the model M to generate one set of inferences for a validation dataset in which the data samples contain the actual values of the feature F, (2) using the model M to generate another set of inferences for a version of the validation dataset in which the values of the feature F have been altered to destroy (e.g., reduce, minimize, etc.) the feature's predictive value, and (3) comparing the performance P1 (e.g., accuracy) of the first set of inferences to the performance P2 (e.g., accuracy) of the second set of inferences. In general, as the difference between P1 and P2 increases, the feature impact of the feature F increases.

In some embodiments, the feature impact of one or more (e.g., all) features of the model's feature set may be determined in parallel. In some cases, the feature impact of a feature F may be negative, indicating that the model's reliance on the feature decreases the model's performance. In some embodiments, features with negative feature impact may be removed from the feature set, and the model may be retrained using the reduced feature set.

In some embodiments, after the feature impacts of one or more features of interest (e.g., all features) have been determined, the feature impacts may be normalized. For example, the feature impacts may be normalized so that the highest feature impact is 100%. Such normalization may be achieved by calculating normalized_F_{IMP}(Fi)=raw_F_{IMP}(Fi)/max(raw_F_{IMP}(all Fi)) for each feature Fi. In some embodiments, the N greatest normalized feature impact scores may be retained, and the other normalized feature impact scores may be set to zero to enhance efficiency. The threshold N may be any suitable number (e.g., 100, 500, 1,000, etc.).

In some embodiments, the feature importance module 441 may determine feature impact scores for one or more (e.g., all) the features of a dataset during the model creation and evaluation phase of the model development process. In some embodiments, the feature importance module may determine feature impact scores for spatial features, image features, and/or other types of features.

In some embodiments, the feature impact scores determined for various features (e.g., features of the same type, features of different types, tabular features, non-tabular features, image features, non-image features, spatial features, non-spatial features, etc.) can be quantitatively compared to each other. This comparison may help the user understand the importance of including various non-tabular data elements (e.g., images) in the dataset. Likewise, the model-specific feature impact scores of a particular feature (e.g., a non-tabular feature) for a set of models may be compared. This comparison may help the user understand which models are doing a good job exploiting the information represented by the feature and which are not.

In some embodiments, the feature engineering module 142 performs feature engineering operations on the modeling data 144. These feature engineering operations may include, for example, combining two or more features and replacing the constituent features with the combined feature; extracting a new feature from the constituent features; dropping features that contain low variation (e.g. are mostly missing, or mostly take on a single value); extracting different aspects of date/time variables (e.g., temporal and seasonal information) into separate variables; normalizing variable values; infilling missing variable values; one hot encoding; text mining; etc.

In some embodiments, the feature engineering module 142 performs spatially-aware feature engineering on the modeling data 144. For example, the feature engineering module 142 may derive “solitary” spatial features representing geometric attributes and/or spatial statistics associated with individual (solitary) spatial objects (each of which may include multiple geometric elements). In addition or in the alternative, the feature engineering module 142 may derive “relational” spatial features of spatial observations based on the spatial relationships between spatial observations. The derivation of relational spatial features may be guided a relational spatial feature engineering controller that sets values of hyperparameters of the relational spatial feature engineering process in accordance with hyperparameter optimization techniques. Some examples of spatially-aware feature engineering methods and operations are described below (see, e.g., “Spatially-Aware Feature Engineering”).

In some embodiments, the feature engineering module 142 performs feature engineering on image features in the modeling data 144. For example, the feature engineering module 142 may extract a new feature (e.g., average pixel intensity, size of an image in bytes, width and/or height of an image in pixels, color histogram of an image, etc.) from the constituent image features. As another example, the feature engineering module 142 may rotate, scale, crop, flip, blur, or otherwise modifying image features to create new image features. Any suitable image feature engineering techniques may be used, including (without limitation) the techniques described below.

With respect to image data, exploratory data analysis operations may include, without limitation, automated assessment of image data quality (e.g., determining the feature importance of the candidate image features, detecting duplicates in the image data using image similarity techniques, detecting missing images, detecting broken image links, detecting unreadable images, etc.), and target-aware previewing of image data (e.g., displaying examples of images per class for classification problems, automated drilldown into images associated with different target subranges for regression problems, etc.). The feature importance of a candidate image feature may be, for example, the feature's univariate feature importance as discussed in detail above. If a missing image is detected (e.g., no link to an image is specified for an image variable of a data sample), the model development system may automatically impute a default image (e.g., an image in which all pixels are the same color, for example, black) for the image variable of the data sample. If a broken image link (e.g., a link to an image specified for an image variable of data sample, but the specified file does not exist at the specified location) or an unreadable image (e.g., specified image exists but is unreadable or corrupted) is detected, the model development system may notify the user, thereby giving the user an opportunity to correct the error or to instruct the system to substitute a default image for the broken image link/unreadable image.

In some instances, the model development system 100 automatically assembles multiple data sources into one modeling table. In such instances, automatic exploratory data analysis may include, without limitation, identifying the data types of the input data (e.g., numeric, categorical, date/time, text, image, location (geospatial), etc.), and determining basic descriptive statistics for one or more (e.g., all) features extracted from the input data. The results of such exploratory data analysis may help the user verify that the system has understood the uploaded data correctly and identify data quality issues early.

In some embodiments, the data partitioning module 143 partitions the modeling data 144 using spatially-aware partitioning techniques. For example, the data partitioning module 143 may partition the modeling data 144 into a training set, a validation set, and a holdout set. Alternatively, the data partitioning module may partition the modeling data 144 into multiple cross-validation sets (or “folds”) and a holdout set. Some examples of spatially-aware data partitioning techniques are described below (see, e.g., “Spatially-Aware Data Partitioning”).

In some embodiments, the data preparation and feature engineering module 140 also performs feature selection operations (e.g., dropping uninformative features, dropping highly correlated features, replacing original features with top principal components, etc.). The data preparation and feature engineering module 140 may provide refined modeling data 150 with a curated (e.g., analyzed, engineered, selected, etc.) set of features 151 to the model creation and evaluation module 160 for use in creating and evaluating models. In some embodiments, the data preparation and feature engineering module 140 determines the importance (e.g., feature importance) or feature impact of the individual feature candidates (132, 134) and/or individual engineered features derived therefrom, and selects a subset of those feature candidates (e.g., the N most important feature candidates, all feature candidates having importance scores above a threshold value, etc.) as the features 151 used by the model creation and evaluation module 160 to generate and evaluate one or more models.

In some embodiments, the data preparation and feature engineering module 140 may use the feature importance scores generated by the feature importance module 141 to determine which features to prune from the dataset, which features to retain for further modeling tasks, and/or which features to select for feature engineering operations. For example, the data preparation and feature engineering module 140 may prune “less important” features from the modeling data 144. In this context, a feature may be classified as “less important” if the feature importance score of the feature is less than a threshold value, if the feature has one of the M lowest feature importance scores among the features in the dataset, if the feature does not have one of the N highest feature importance scores among the features in the dataset, etc. As another example, the system may engineer new features (e.g., “derived features” or “engineered features”) from “more important” features in the dataset. In this context, a feature may be classified as “more important” if the feature's importance score is greater than a threshold value, if the feature has one of the N highest importance scores among the features in the dataset, if the feature does not have one of the M lowest importance scores among the features in the dataset, etc. In addition or in the alternative, the data preparation and engineering module 140 may allocate more resources to feature engineering tasks involving the more important features of the dataset.

In some embodiments, the data preparation and feature engineering module 140 may present (e.g., display) an evaluation of a dataset to a user of a model development system 100, and the presented evaluation may include the feature importance scores of the dataset's features (e.g., including but not limited to any location features) and/or information derived therefrom. For example, for one or more models, the data preparation and feature engineering module 140 may (1) identify “more important” and/or “less important features”, (2) display the feature importance scores of the features, and/or (3) rank the features by their feature importance scores.

The model creation and evaluation module 160 may create one or more models and evaluate the models to determine how well they solve the data analytics problem at hand. In some embodiments, the model creation and evaluation module 160 performs model-fitting steps to fit models to the training data (e.g., to the features 151 of the refined modeling data 150). The model-fitting steps may include, without limitation, algorithm selection, parameter estimation, hyperparameter tuning, scoring, diagnostics, etc. The model creation and evaluation module 160 may perform model fitting operations on any suitable type of model, including (without limitation) decision trees, neural networks, support vector machine models, regression models, boosted trees, random forests, deep learning neural networks, k-nearest neighbors models, naïve Bayes models, etc. In some embodiments, the model creation and evaluation module 160 performs post-processing steps on fitted models. Some non-limiting examples of post-processing steps may include calibration of predictions, censoring, blending, choosing a prediction threshold, etc.

In some embodiments, the data preparation and feature engineering module 140 and the model creation and evaluation module 160 form part of an automated model development pipeline, which the model development system 100 uses to systematically evaluate the space of potential solutions to the data analytics problem at hand. In some cases, results 165 of the model development process may be provided to the data preparation and feature engineering module 140 to aid in the curation of features 151. Some non-limiting examples of systematic processes for evaluating the space of potential solutions to data analytics problems are described in U.S. patent application Ser. No. 15/331,797 (now U.S. Pat. No. 10,366,346).

During the process of evaluating the space of potential modeling solutions for a data analytics problem, some embodiments of the model creation and evaluation module 160 may allocate resources for evaluation of modeling solutions based in part on the feature importance scores of the features in the dataset (e.g., refined modeling data 150) representing the data analytics problem. In general, the model creation and evaluation module 160 may select or suggest potential modeling solutions that are predicted to be suitable or highly suitable for a dataset. When determining the suitability of a predictive modeling procedure for a data analytics problem, the model creation and evaluation module 160 may treat the characteristics of the more important features of the dataset as the characteristics of the data analytics problem. In this way, the model creation and evaluation module 160 may generate “suitability scores” for potential modeling solutions, such that the suitability scores are tailored to the more important features of the dataset. The model creation and evaluation module may then allocate computational resources to model training and evaluation tasks based on those suitability scores. Thus, tailoring the suitability scores to the more important features of the dataset may result in resources being allocated to the evaluation of potential modeling solutions based in part on feature importance scores.

In some embodiments, the model creation and evaluation module 160 selects models for blending based on the feature importance scores, and blends the selected models. The model creation and evaluation module 160 may use any suitable technique to select models for blending. For example, “complementary top models” may be selected for blending. In this context, “complementary top models” may include high-performing models that achieve their high performance (e.g., high accuracy) through different mechanisms. The model creation and evaluation module 160 may classify a model as a “top” model if a score representing the model's performance is greater than a threshold, if the model has one of the N highest scores among the fitted models, if the model does not have one of the M lowest scores among the fitted models, etc. The model creation and evaluation module 160 may classify two models as “complementary” models if (1) the most important features for the models (e.g., the features having the highest feature importance scores for the models) are different, or (2) a feature that has high importance to the first model has low importance to the second model, and a feature that has low importance to the first model has high importance to the second model. In this context, a feature may have “high importance” to a model if the feature has a high feature importance score for the model (e.g., the highest feature importance score, one of the highest N feature importance scores, a feature importance score greater than a threshold value, etc.). In this context, a feature may have “low importance” to a model if the feature has a low feature importance score for the model (e.g., the lowest feature importance score, one of the lowest N feature importance scores, a feature importance score lower than a threshold value, etc.). In some embodiments, the model creation and evaluation module 160 may use the above-described classification techniques to select two or more complementary top models for blending. In some cases, blending complementary top models may yield blended models with very high performance, relative to the component models. By contrast, blending non-complementary models may not yield blended models with significantly better performance than the component models.

In some embodiments, a model creation and evaluation module 160 may present (e.g., display) evaluations of models 170 to users. Such model evaluations may include feature importance scores of one or more features for one or more models (e.g., the top models). Presenting the feature importance scores to the user may assist the user in understanding the relative performance of the evaluated models. For example, based on the presented feature importance scores, the user (or the system) may identify a top model M that is outperforming the other top models, and one or more features F that are important to the model M but not to the other top models. The user may conclude (or the system may indicate) that, relative to the other top models, the model M is making better use of the information represented by the features F.

The model development system 100 may facilitate the use of the above-referenced solution-space evaluation techniques to evaluate potential solutions to data analytics problems involving spatial data. Optionally, these data analytics problems may also involve non-spatial data (e.g., image data).

In some cases, the model generated by the creation and evaluation module 160 includes a gradient boosting machine (e.g., gradient boosted decision tree, gradient boosted tree, boosted tree model, any other model developed using a gradient tree boosting algorithm, etc.). Gradient boosting machines are generally well-suited to data analytics problems involving heterogeneous tabular data.

In some cases, the model generated by the creation and evaluation module 160 includes a feed-forward neural network, with zero or more hidden layers. Feed forward neural networks are generally well-suited to data analytics problems that involve combining data from multiple domains (e.g., spatial data and image data; spatial data and numeric, categorical, or text data, etc.), pairs of inputs from the same domain (e.g., pairs of spatial datasets, pairs of images, pairs of text samples, pairs of tables, etc.), multiple inputs from the same domain (e.g., spatial datasets, sets of images, sets of text samples, sets of tables, etc.), or combinations of singular, paired, and multiple inputs from a variety of domains (e.g., spatial data, image data, text data, and tabular data).

In some cases, the model generated by the creation and evaluation module 160 includes a regression model, which can generally handle both dense and sparse data. Regression models are often useful because they can be trained more quickly than other models that can handle both dense and sparse data (e.g., gradient boosting machines or feed forward neural networks).

In some embodiments, the model development system 100 enables highly efficient development of solutions to data analytics problems involving spatial data. Existing techniques for developing spatial models are generally inefficient and expensive, and do not always yield optimal solutions to the problems at hand. In contrast to the machine learning domain, in which tools for model development have become increasingly automated over the last decade, techniques for developing spatial models remain largely artisanal. Experts tend to build and evaluate potential solutions in an ad hoc fashion, based on their intuition or previous experience and on extensive trial-and-error testing. However, the space of potential solutions for spatial data analytics problems is generally large and complex, and the artisanal approach to generating solutions tends to leave large portions of the solution space unexplored.

The model development system 100 disclosed herein can address the above-described shortcomings of conventional approaches by systematically and cost-effectively evaluating the space of potential solutions for spatial data analytics problems. In many ways, the conventional approaches to solving spatial data analytics problems are analogous to prospecting for valuable resources (e.g., oil, gold, minerals, jewels, etc.). While prospecting may lead to some valuable discoveries, it is much less efficient than a geologic survey combined with carefully planned exploratory digging or drilling based on an extensive library of previous results.

In some embodiments, the model development pipeline tailors its search of the solution space based on the computational resources available to the model development system 100. For example, the model development pipeline may obtain resource data indicating the computational resources available for the model creation and evaluation process. If the available computational resources are relatively modest (e.g., commodity hardware), the model development pipeline may extract feature candidates (132, 134), select features 151, select model types, and/or select machine learning algorithms that tend to facilitate computationally efficient creation and evaluation of modeling solutions. If the computational resources available are more substantial (e.g., graphics processing units (GPUs), tensor processing units (TPUs), or other hardware accelerators), the model development pipeline may extract feature candidates (132, 134), select features 151, select model types, and/or select machine learning algorithms that tend to produce highly accurate modeling solutions at the expense of using substantial computational resources during the model creation and evaluation process.

An example of a model development system 100 specifically configured to develop spatially-aware models 170 has been described. More generally, the model development system 100 receives raw modeling data 110 and uses it to develop one or more models (e.g., spatially-aware machine learning models, etc.) that solve a problem in a domain of modeling or data analytics. The modeling data may include spatial data. Optionally, the modeling data may include tabular data (e.g., numeric data, categorical data, etc.). Optionally, the modeling data may include other non-tabular data (e.g., image data, natural language data, speech data, auditory data, and/or time series data).

### Spatial Feature Extraction

As discussed above, conventional machine learning and artificial intelligence tools generally deal with spatial data by treating the coordinates of the locations of spatial objects as independent numeric features. For example, a location represented by latitude and longitude coordinates may be mapped to one numeric feature representing latitude and an independent numeric feature representing longitude. Likewise, a location represented by x-, y-, and z-coordinates may be mapped to one numeric feature representing an x-coordinate, an independent numeric feature representing a y-coordinate, and another independent numeric feature representing a z-coordinate.

Representing the locations of spatial objects as independent coordinate values leads to inefficiencies in the data preparation process and to poor performance in the model generation process. With respect to data preparation, conventional tools generally require data analysts to manually convert spatial data models from a native format (e.g., vector format) to a coordinate-based representation of spatial objects' geometries. This conversion can be time-consuming and error prone. With respect to model generation, by treating the coordinates of a spatial object's location as independent values, this naïve representation of location allows downstream components to be aware of the numeric relationship between coordinate values on separate axes, but makes it difficult or impossible for downstream components to understand the spatial relationships between locations of spatial objects in two, three, or more dimensions. Thus, automated analyses premised on an understanding of the relative spatial relationships between and among spatial objects (e.g., derivation of spatially lagged features, determination of local indicators of spatial autocorrelation, spatial hotspot and/or cold spot detection, etc.) either are not performed or produce inaccurate results.

In some embodiments, a spatial feature extraction module (122, 822) can extract spatial data from raw modeling data 110 or raw inference data 810 and optionally perform one or more transformations on the extracted spatial data to generate spatial feature candidates (132, 832) that facilitate the implementation of spatially-aware operations in downstream components of a model development system 100 (e.g., data preparation and feature engineering module 140, model creation and evaluation module 160, etc.) or model development system 800 (e.g., data preparation and feature engineering module 840, model management and monitoring module 870, interpretation module 880, etc.). In some embodiments, the spatial feature extraction module stores the extracted (and optionally transformed) coordinates of each location associated with each spatial object as related values of a “location feature” rather than storing the coordinates as independent values of unrelated numeric features.

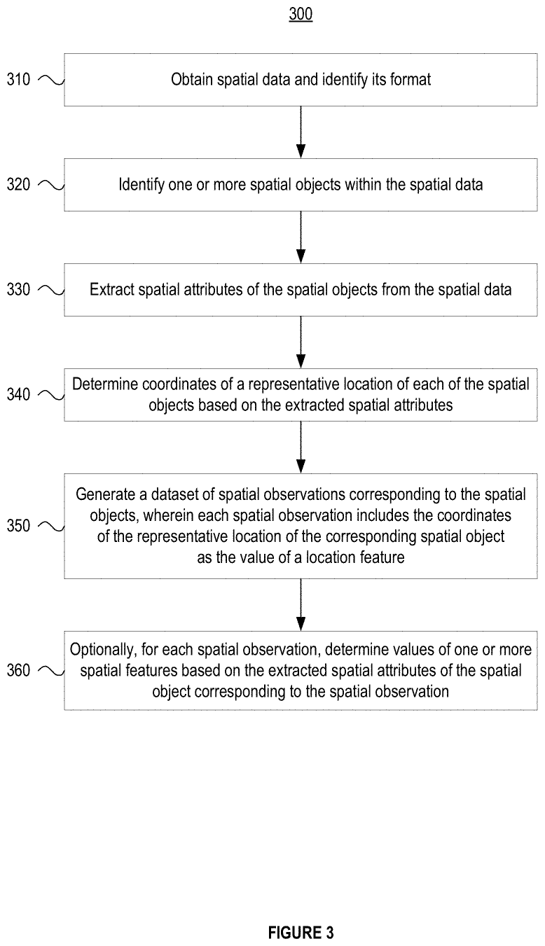

FIG. 3 shows a flowchart of a spatial feature extraction method 300, according to some embodiments. A spatial feature extraction module (122, 822) may use the spatial feature extraction method 300 to automatically extract spatial information from spatial data and generate spatial feature candidates (132, 832). Some embodiments of the steps 310-360 of the spatial feature extraction method 300 are described below.

At step 310, the spatial feature extraction module obtains spatial data and identifies its format. The spatial data may be encoded in any suitable format, including (without limitation), a vector format, a native geospatial format (e.g., .geojson, .shp, etc.), well-known text (WKT) format, well-known binary (WKB) format, a raster format (e.g., GeoTIFF), etc. The spatial data's format may be identified using any suitable technique based on any suitable information. For example, the spatial data's format may be identified based on user input, metadata and/or the file extension of a file containing the spatial data, etc.

At step 320, the spatial feature extraction module identifies spatial objects represented by the spatial data. Any suitable techniques may be used to identify the spatial objects. In some formats (e.g., vector format or native geospatial format), the spatial data may expressly identify the spatial objects. In other formats (e.g., well-known text), the spatial data may expressly identify the spatial objects or may be organized into records (e.g., rows of a table) such that each record represents a spatial object. For spatial data in raster format, the feature extraction module may use computer vision techniques to identify spatial objects in one or more images.

At step 330, the spatial feature extraction module extracts spatial attributes of the spatial objects from the spatial data. Any suitable spatial attributes may be extracted, including (without limitation) the locations of geometric elements of the spatial objects, the geometric properties of the spatial objects, etc. In some formats (e.g., vector format or native geospatial format), the spatial data may expressly identify spatial attributes of the spatial objects. In other formats (e.g., well-known text), the spatial data may be organized into records (e.g., rows of a table) with fields (e.g., columns of the table) that represent attributes of the spatial objects. For spatial data in raster format, the spatial data may include georeferencing metadata indicating the location(s) depicted in the image, and the feature extraction module may use computer vision techniques to identify geometric elements and properties of the spatial objects. In some embodiments, the spatial feature extraction module may transform the extracted location data from the frame of reference or coordinate system used in the spatial data to a new frame of reference or coordinate system, as described above.

At step 340, the spatial feature extraction module determines the coordinates of a representative location of each of the spatial objects based on the object's extracted spatial attributes. Any suitable representative location may be used, including (without limitation) the location of a central tendency of the spatial object. For a spatial object represented by a single point, the location of the object's central tendency may be the location of the point. For a spatial object represented by multiple points, the location of the object's central tendency may be the “mean center” of the points (e.g., a point at the location (x, y, z), where x, y, and z are the averages of the x-coordinates, y-coordinates, and z-coordinates of the locations of all the points, respectively) or the “median center” (also known as the “central feature”) of the points (e.g., the point in the spatial object's set of points for which the sum of the distances from the point to all other points in the set is smallest). For a spatial object represented by a line or a polygon, the central tendency of the object may be the centroid of the line or polygon. For a spatial object represented by multiple lines and/or polygons (and optionally one or more points), the central tendency of the object may be the weighted mean center or geometric median of the central tendencies of the object's individual geometric elements. Any suitable weighting scheme may be used. For example, the weight of each point may be 1, the weight of each line may be the line's length, and the weight of each polygon may be the polygon's area. The location of the spatial object's central tendency may be represented in the frame of reference or coordinate system used in the spatial data or in the transformed frame of reference or coordinate system, as described above.

At step 350, the spatial feature extraction module generates a dataset of spatial observations corresponding to the spatial objects, wherein each spatial observation includes the coordinates of the representative location of the corresponding spatial object as the value of a location feature. Optionally, the spatial observations may include additional locations for the spatial object, e.g., the locations of the central tendencies of the individual geometric elements within each spatial object.

At step 360, the spatial feature extraction module optionally determines the values of one or more other spatial features of the spatial objects based on the extracted spatial attributes, and stores the value(s) of each spatial object's other spatial features in the object's spatial observation. In some embodiments, the dataset generated by the spatial feature extraction module pursuant to method 300 is a processed modeling dataset 130 or processed inference dataset 830, and the location features and other spatial features of this dataset are spatial feature candidates (132, 832).

The benefits of automatically performing the spatial feature extraction tasks described herein may include, without limitation, (1) facilitating automation of downstream tasks and analyses (e.g., spatially-aware feature engineering, spatially-aware data partitioning, spatially-aware determination of feature importance etc.) that rely on accurate indications of relative spatial positioning between spatial objects represented by observations, and (2) enabling automated machine learning tools to model true relative spatial relationships between spatial objects.

### Spatially-Aware Data Partitioning

Spatial data often exhibit properties (e.g., “spatial autocorrelation” or “spatial dependence”) that violate assumptions made in conventional statistical modeling processes, such as the assumption that distinct features are independent and identically distributed random variables. These properties of spatial data can interfere with the development of machine learning models. For example, the development of machine learning models generally involves partitioning a dataset into training, validation, and holdout partitions; applying machine learning algorithms to the training data to train a machine learning model; and testing the trained model on the validation and holdout data to assess the model's performance. The purpose of partitioning the dataset in this manner is to avoid training and testing the model on the same data, which can lead to an overly optimistic assessment of how the model is likely to perform in the future when applied to different data.

However, when spatial autocorrelation (or spatial dependence) exists within a spatial dataset, conventional dataset partitioning techniques tend to be ineffective, because the same spatial dependence structures (e.g., patterns of systemic spatial variation in feature values, co-variation of feature values within a geographic area, relationships between the spatial proximity of spatial objects and the variation in the values of the spatial objects' features, etc.) tend to be present in the training data, the validation data, and the holdout data. Likewise, even if cross-validation is performed, the same spatial dependence structures tend to be present in the different cross-validation folds.

In other words, conventional techniques for partitioning spatial data tend to cause a form of data leakage by carrying spatial dependency structures across data partitions. The inventors have recognized and appreciated that this form of data leakage (referred to herein as “spatial dependence structure leakage”) often arises from spatial objects that are close spatial neighbors being distributed across data partitions. Such leakage is different from traditional target leakage, can be present in addition to target leakage, and can be difficult to disentangle when both are present. The presence of this spatial dependency structure leakage generally results in overly optimistic validation and holdout results due to overfitting on the leaked spatial dependency structures.

Thus, there is a need for spatial data partitioning techniques that reduce spatial dependence structure leakage. The present disclosure describes a spatial data partitioning method that uses spatial autocorrelation analysis to determine the parameters of a spatial blocking scheme that, when applied to the spatial dataset, reduces (e.g., minimizes) cross-block placement of spatial dependence structures. Spatial observations from the spatial dataset are then partitioned at the block level, such that spatial dependence structure leakage is reduced (e.g., minimized).

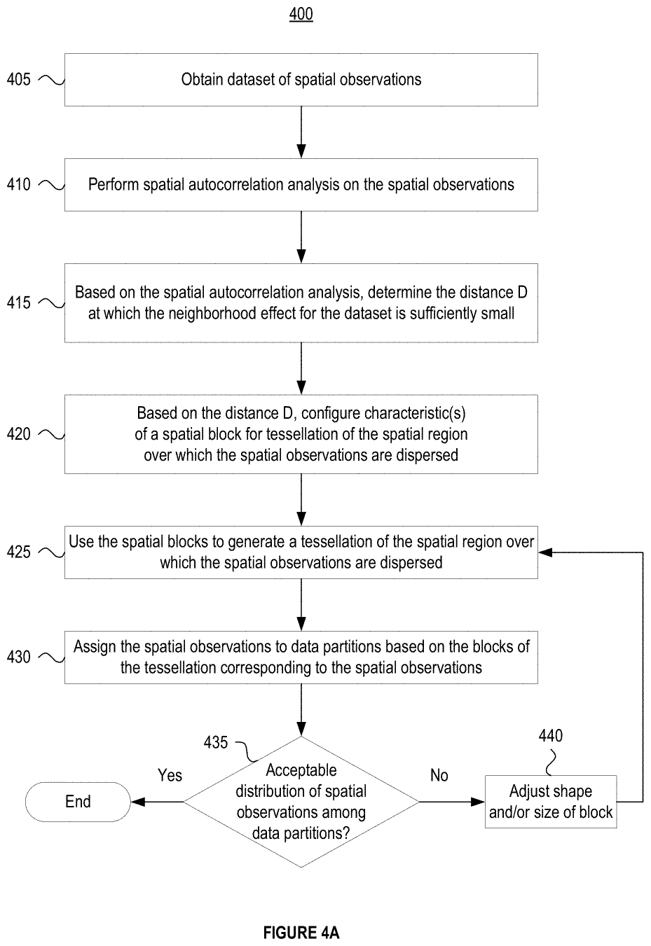

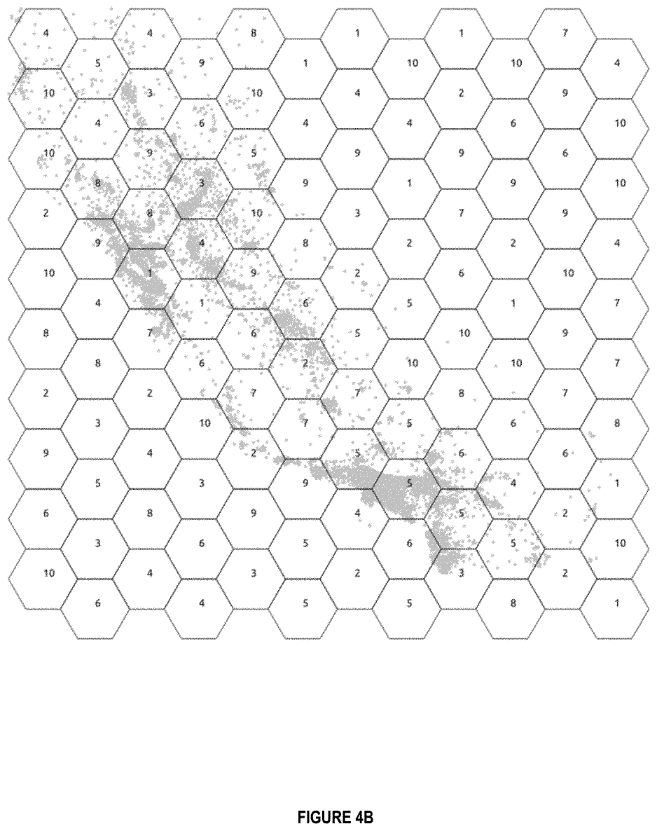

Referring to FIG. 4A, a spatial data partitioning method 400 may include steps of obtaining 405 a dataset of spatial observations; performing 410 spatial autocorrelation analysis on the spatial observations; based on the autocorrelation analysis, determining 415 the distance D at which the neighborhood effect for the dataset is sufficiently small; based on the distance D, configuring 420 one or more characteristics of a spatial block for tessellation of a spatial region over which the spatial observations are dispersed; using the spatial block, generating 425 a tessellation of the spatial region over which the spatial observations are dispersed; and assigning 430 the spatial observations to data partitions based on the respective blocks of the tessellation with which the spatial observations are associated. If this assignment of spatial observations to data partitions yields an acceptable distribution of spatial observations among data partitions (step 435), the data partitioning method 400 ends. Otherwise, the shape and/or size of the spatial block may be adjusted and steps 425-435 may be repeated. Some embodiments of the steps of the spatial data partitioning method 400 are described in further detail below. Referring to FIGS. 1 and 2, a data partitioning module 143 of a data preparation and feature engineering module 140 may use the spatial partitioning method 400 to automatically partition the observations of a spatial dataset (e.g., processed modeling data 130) into training, validation (e.g., cross-validation), and holdout sets.

Referring again to FIG. 4A, in step 405, a dataset of spatial observations is obtained. The dataset may be, for example, the processed modeling data 130 provided by the feature extraction modules (122, 124) of a model development system 100, or the modeling data 144 of a data preparation and feature engineering module 140 (which may or may not have already been processed by a feature importance module 141 and/or a feature engineering module 142 as described elsewhere in the present disclosure).

In step 410, the data partitioning module 143 performs spatial autocorrelation analysis on the spatial observations of the dataset. Performing spatial autocorrelation analysis may include calculating the value of an indicator of spatial autocorrelation over a range of spatial lags (distances) for the entire dataset or for portions thereof. The value of the indicator of spatial autocorrelation may be calculated with respect to the dataset's target. Any suitable indicator of spatial autocorrelation (e.g., local or global variants of Moran's I, Geary's C, or Getis's G, etc.) may be used to assess the level of spatial autocorrelation in the dataset. In some embodiments, the value of the indicator of spatial autocorrelation is calculated for an initial lag Do and recalculated for a finite set of incrementally increasing lags (D₁, D₂, . . . ). Any suitable stopping criterion may be used to terminate the spatial autocorrelation analysis. For example, the data partitioning module 143 may terminate the analysis when the value of the indicator reduces to zero, the value of the indicator reduces to a value less than a specified threshold, the value of the indicator asymptotically approaches a minimum value, the value of the lag reaches an upper threshold, etc. An upper threshold for the lag may be determined based on the size of the spatial region over which the spatial observations of the dataset are dispersed.

In step 415, the data partitioning module 143 determines, based on the spatial autocorrelation analysis, a distance D_{N} (e.g., the minimum distance D_{N}) at which the level of spatial autocorrelation (sometimes referred to herein as the “neighborhood effect”) in the dataset is sufficiently small. Any suitable criteria may be used to determine what value of the indicator of spatial autocorrelation indicates that the neighborhood effect for the dataset is sufficiently low. For example, the neighborhood effect may be determined to be sufficiently low when the value of the indicator reduces to zero, the value of the indicator reduces to a value less than a specified threshold, the value of the indicator asymptotically approaches a minimum value, etc.

In step 420, based on the distance D_{N} determined in step 415, the data partitioning module 143 configures one or more characteristics of a spatial block for tessellation of a spatial region over which the spatial observations are dispersed. The boundaries of a spatial region over which the spatial observations are dispersed may be determined using any suitable technique. In some embodiments, the dimensions and location of a bounding box (e.g., a minimum bounding box) that circumscribes the representative locations of all the spatial objects corresponding to the spatial observations of the dataset may be determined.

A tessellation of a spatial region is a partitioning of the region into spatial units (“blocks”) of a consistent size and shape (e.g., blocks of the same size and same regular shape). In general, the blocks used for tessellation of the spatial region over which the spatial observations are dispersed may have any suitable shape (e.g., square, rectangle, hexagon, cube, rectangular prism, etc.) and suitable size S (e.g., dimensions). An example of a tessellation can be seen in FIG. 4B, which shows a visualization of an example of the outcome of partitioning a spatial dataset using the spatial partitioning method 400. In the example of FIG. 4B, each grey dot corresponds to a spatial observation representing a residential property in California. As can be seen, in the example of FIG. 4B a spatial region circumscribing the spatial observations has been tessellated into regular hexagons of the same size.

Configuring characteristics of a spatial block for tessellation of the spatial region may include determining the shape and size of the block. The data partitioning module 143 may use any suitable technique to determine the block's shape. In some embodiments, the block's shape is user-specified. In some embodiments, a default block shape (e.g., square, hexagon, etc.) is chosen. In some embodiments, the data partitioning module 143 determines the size S of the block based on the distance D_{N}. The “size” S of the block may include any suitable dimension of the block, for example, the inradius or circumradius of a block shaped as a regular polygon, the length of a side of a block shaped as regular polygon, the length and width of a block shaped as a rectangle, etc. In some embodiments, the size S of the block is set to α*D_{N}, where the value of α is between 1 and 3 (e.g., α=1.5). The prevalence of spatial dependency structures within a spatial dataset generally decreases as the indicator of spatial autocorrelation decreases, so determining the size of the block in this manner generally reduces the prevalence of spatial dependency structures in the dataset to a minimum (or near-minimum) level.

In step 425, the data partitioning module 143 tessellates the spatial region over which the spatial observations are dispersed using blocks having the determined shape and size. Any suitable technique for generating the tessellation of the spatial region using blocks of the determined shape and size may be used.

In step 430, the data partitioning module 143 assigns the dataset's spatial observations to a set of data partitions based on the respective blocks with which the spatial observations are associated. Any suitable number of data partitions may be used. In some embodiments, the observations are assigned to three data partitions (training data, validation data, and holdout data). In some embodiments, the observations are assigned a holdout data partition and to a suitable number of cross-validation data partitions (e.g., between 2 and 30 cross-validation partitions).

In some embodiments, the assignment of spatial observations to partitions is implemented by assigning the spatial blocks of the tessellation to respective data partitions, such that all observations located within a given block (e.g., all observations representing spatial objects having representative locations circumscribed within the boundaries of the block) are assigned to the data partition associated with the block. In the example of FIG. 4B, 10 data partitions are used, with each data partition being identified by an integer index between 1 and 10. Each block is associated with the data partition having the index shown within the block, and all the observations located within a block are assigned to the block's data partition.

The data partitioning module 143 may assign blocks (and the observations located within the blocks) to data partitions using any suitable technique. In some embodiments, a feature is added to the dataset to indicate the index of the partition to which each observation is assigned. In some embodiments, blocks are randomly assigned to data partitions. Random assignment of blocks to data partitions tends to be an effective strategy for limiting the spatial dependence across partitions because, as discussed above, the sizes of the blocks have been selected to reduce (e.g., minimize) the prevalence of cross-block (or “inter-block”) spatial dependency structures. In some embodiments, the otherwise random assignment of blocks to partitions is constrained to prohibit adjacent blocks from being assigned to the same partition, thereby reducing the risk of inadvertently reintroducing spatial leakage. In some embodiments, the otherwise random assignment of blocks to partitions is constrained such that substantially the same number of blocks is assigned to each data partition, or such that substantially the same number of non-empty blocks (e.g., blocks in which at least one spatial observation is located) is assigned to each data partition.

At step 435, the data partitioning module 143 determines whether the assignment of spatial observations to data partitions has yielded an acceptable distribution of spatial observations among the data partitions. Any suitable criteria may be used to determine whether the distribution of spatial observations among the data partitions is acceptable. In some embodiments, the distribution is acceptable if the total number of observations assigned to each partition exceeds a minimum threshold. The minimum threshold value may be the β*num_observations/num_partitions, where p is a distribution factor having a value between 0 and 1, num_observations is the number of observations in the dataset, and num_partitions is the number of data partitions. In some embodiments, p is between 0.25 and 0.75 (e.g., 0.50).

If this assignment of spatial observations to data partitions yields an acceptable distribution of spatial observations among data partitions (step 435), the data partitioning method 400 ends. Otherwise, step 430 may be repeated and the acceptability of the new distribution of spatial observations among the data partitions may be reassessed.

Alternatively, if the distribution of spatial observations among the data partitions is unacceptable, the shape and/or size of the spatial block may be adjusted and steps 425-435 may be repeated. As discussed above, setting the size S of the blocks to α*D_{N} can be advantageous because doing so generally minimizes the prevalence of spatial dependency structures within a spatial dataset or reduces the prevalence of such structures to acceptable levels. However, as the size S of the block increases, the total number of blocks in a given region decreases and the variation between the number of spatial observations within each block may increase, which can make it difficult or impossible to assign a sufficient number of observations to each data partition while maintaining the practice of assigning all observations in each block to the same respective partition.

Thus, in step 440, to facilitate the task of assigning spatial observations to data partitions with an acceptable distribution, a different shape may be selected for the spatial block and/or the size S of the block may be reduced from its current value, even if doing so increases the amount of spatial dependence structure leakage in the dataset.

In some cases, at the conclusion of the data partitioning method 400, the partitioned dataset may still exhibit some spatial dependence structure leakage, because there may be some spatial dependency between observations in neighboring blocks, and those neighboring blocks may be assigned to different partitions. In some embodiments, spatial dependence structure leakage may be further reduced by selectively adding buffers around the training datasets or testing (e.g., validation or holdout) datasets so that observations in neighboring blocks assigned to different partitions are not used for both the training and testing of any given model.

The creation of buffer regions between the training data and the testing data for a model may be implemented using any suitable technique. In some embodiments, after data partitions are allocated to the training and testing datasets, all spatial observations ‘SOTrain’ located in any blocks of training data that border any blocks of testing data are removed from the training data. Alternatively, all spatial observations ‘SOTest’ located in any blocks of testing data that border any blocks of training data may be removed from the testing data.

### Spatially-Aware Feature Importance

As described above, the treatment of spatial coordinates as separate, unbounded numeric variables may not appropriately represent their underlying spatial properties to downstream machine learning tools. For example, failure to account for the spatial relationships between the coordinates of a spatial object's location and/or between the locations of spatial objects during the data partitioning process can lead to spatial dependency structure leakage, which can artificially inflate the accuracy of models during testing. Furthermore, failure to account for these spatial relationships when assessing “feature importance” can artificially inflate the importance of location features relative to other spatial features and non-spatial features, which tends to lead to sub-optimal outcomes in feature selection and feature engineering, and also hinders the performance of model interpretation tools.

The inventors have recognized and appreciated that the artificial inflation of the importance of location features can arise from an interplay between (1) using permutation importance analysis to estimate feature importance, and (2) failing to limit the permutation importance analysis to locations that lie within spatial boundaries indicated by the dataset. Permutation importance for a feature F is determined by (1) calculating a first score representing a model's performance (e.g., accuracy) with respect to a dataset, (2) permuting (e.g., randomly shuffling) the values of the feature F across the observations within the dataset, thereby breaking the relationship between the feature F and the model's target, (3) calculating a second score representing the model's performance with respect to the permuted dataset, and (4) determining the difference between the first score and the second score, which indicates the importance of the feature F to the model's performance (e.g., the extent to which the model relies on the feature F to generate accurate predictions).

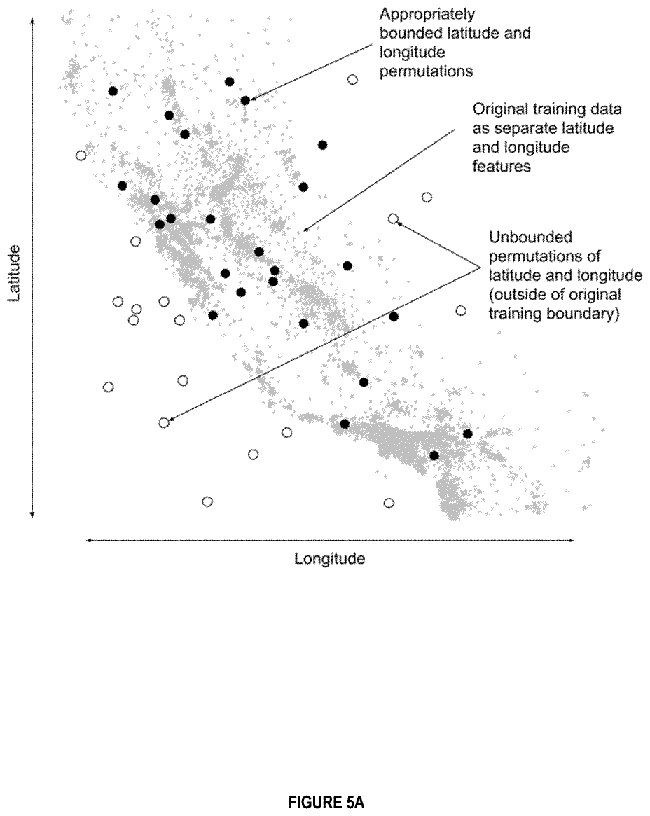

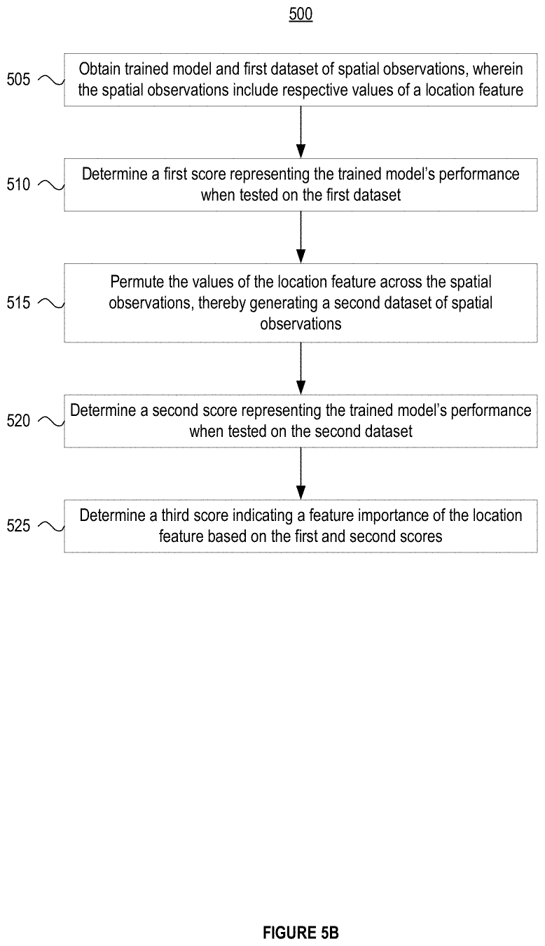

However, when a location is represented by a set of two or more coordinates and the values of one coordinate are permuted independently of the values of the other coordinates, the resulting sets of coordinates may not lie within the spatial boundaries of the original dataset. This phenomenon is illustrated in FIG. 5A, which depicts locations of spatial objects within an original dataset as grey dots and locations generated by independently permuting the values of the spatial observations' coordinates as black dots and white dots ringed in black. The locations of the spatial objects (represented by the grey dots) are all interior to the border of California. The locations represented by the black dots (locations generated by permuting the values of coordinates independently) are within the border of California, and therefore may be suitable for calculating the permutation importance of location information for this dataset. However, the locations represented by the white dots (also generated by permuting the values of coordinates independently) are outside the border of California, and therefore are not suitable for calculating the permutation importance of location information for this dataset. (Some of the white dots are actually located in the Pacific Ocean, which is particularly problematic in the context of the data analysis task for which the original dataset is intended, i.e., modeling the values of residential properties in California).

More generally, conventional data analysis tools do not accurately infer constraints (boundaries) on the locations of spatial objects when permuting the coordinates of objects' location, and therefore do not limit the feature importance analysis to locations within the boundaries indicated by the dataset. This failure to adhere to the spatial boundaries of the dataset tends to artificially inflate the feature importance of location features, because the out-of-bounds locations tend to drag down the model's overall performance. Thus, there is a need for techniques for accurately estimating the importance of location information to spatial data analytics models. The present disclosure describes a spatially-aware method for estimating the importance of location features, whereby the sets of coordinates representing locations in a spatial dataset are jointly permuted, rather than permuting the individual coordinates independently. In this way, the spatially-aware method permutes the locations in the original dataset across the dataset's observations, rather than creating new combinations of coordinates representing new locations not present in the original dataset. When applied to spatial data analytics models, this spatially-aware method tends to more accurately estimate the importance of location features.

Referring to FIG. 5B, a spatially-aware method 500 for determining location feature importance may include steps of obtaining (505) a trained data analytics model and a first dataset of spatial observations including respective values of a location feature; determining (510) a first score representing the trained model's performance when tested on the first dataset; permuting (515) the values of the location feature across the spatial observations, thereby generating a second dataset of spatial observations; determining (520) a second score representing the trained model's performance when tested on the second dataset; and determining (525) a third score indicating a feature importance of the location feature based on the first and second scores. Some embodiments of the steps of the method 500 for determining location feature importance are described in further detail below. Referring to FIGS. 1, 2 and 8, a feature importance module 141 of a data preparation and feature engineering module 140 may use the method 500 to automatically determine the importance of a location feature of a spatial dataset (e.g., processed modeling data 130, refined modeling data 150, processed inference data 830, refined inference data 850, etc.) to one or more models.

Referring again to FIG. 5B, in step 505, the feature importance module 141 obtains a trained data analytics model and a dataset of spatial observations. The dataset may be, for example, the processed modeling data 130 provided by the feature extraction modules (122, 124) of a model development system 100, or the modeling data 144 of a data preparation and feature engineering module 140. Each of the spatial observations may include (1) a value of a location feature indicating a set of coordinates of a representative location of a respective spatial object, (2) respective values of one or more other features, and (3) a respective value of a target variable.

In step 510, the feature importance module 141 tests the trained model on the first dataset and determines a first model evaluation score representing the model's performance during the testing. The model's performance may be scored using any suitable metric (e.g., accuracy, positive predictive value or precision, negative predictive value, sensitivity or recall, specificity, F1 score, area under the receiver operating characteristic curve (AUC-ROC), logarithmic loss (“log loss”), Gini coefficient, concordant/discordant ratio, root mean squared error (“RMSE”), root mean squared logarithmic error (“RMSLE”), R-Squared, adjusted R-Squared, etc.). One of ordinary skill in the art will appreciate that determining the value of each of these metrics generally involves inputting the observations of the first dataset to the model, obtaining the model's estimated values for the target variable, and comparing the model's estimated target values to the actual target values.

In step 515, the feature importance module 141 permutes the values of the location feature across the spatial observations, thereby generating a second dataset of spatial observations in which the relationship between the values of the location feature and the values of the target variable is broken. In some embodiments, the permuting (or “shuffling”) is performed by reassigning (e.g., randomly reassigning) the respective values of the location feature from their original observations to different observations, such that all coordinates of the location originally associated with a given observation are reassigned to another observation. This shuffling operation may reduce (e.g., destroy) the predictive value of the location feature within the second dataset. Other techniques for reducing (e.g., destroying) the predictive value of the location feature are possible, including, without limitation, assigning each observation the same value for the location feature.

In step 520, the feature importance module 141 retests the trained model on the second dataset and determines a second model evaluation score representing the model's performance during the retesting. The model's performance may be scored using any suitable metric (e.g., accuracy, positive predictive value or precision, negative predictive value, sensitivity or recall, specificity, F1 score, area under the receiver operating characteristic curve (AUC-ROC), logarithmic loss (“log loss”), Gini coefficient, concordant/discordant ratio, root mean squared error (“RMSE”), root mean squared logarithmic error (“RMSLE”), R-Squared, adjusted R-Squared, etc.). The metric used in step 520 to determine the second model evaluation score is generally the same metric used in step 510 to determine the first model evaluation score.

In step 525, the feature importance module 141 determines a third score indicating the feature importance of the location feature to the model based on the first and second scores. For example, the third score may be the difference between the first score and the second score. In some embodiments, a function is used to determine the third score based on the first and second scores, such that the feature importance score generally increases as the difference between the first accuracy score and the second accuracy score increases.

The model development system 100 and/or the model deployment system 800 may use the feature importance scores determined by the feature importance module 141 (e.g., for location features and/or for non-location features) to present evaluations of models, to guide aspects of model development and deployment, or for any other suitable purpose. Some non-limiting examples of uses or applications of feature importance scores are described above.

### Spatially-Aware Feature Engineering

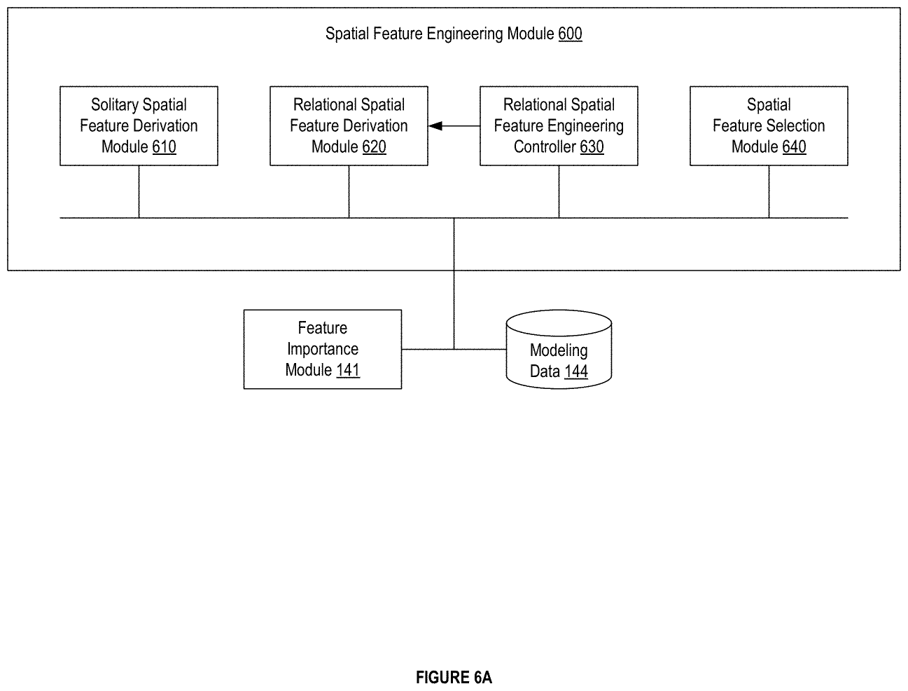

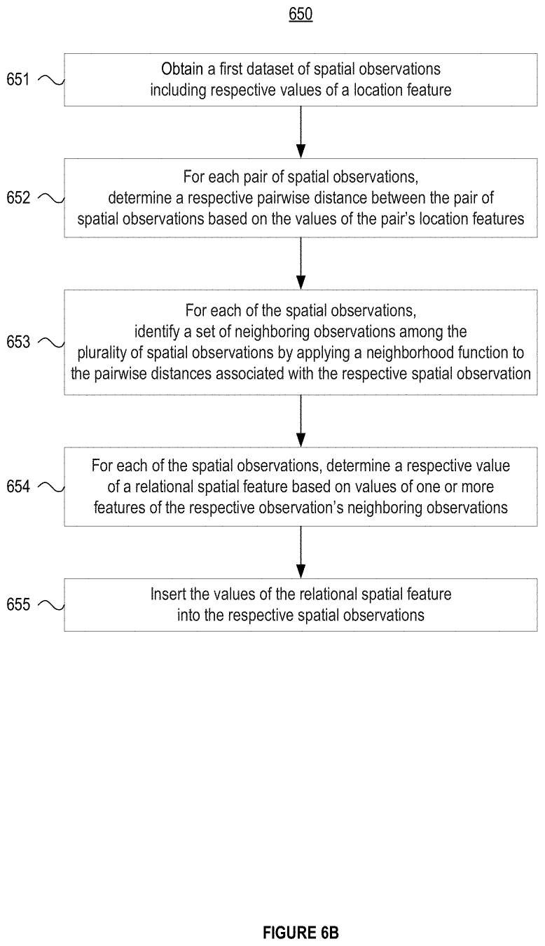

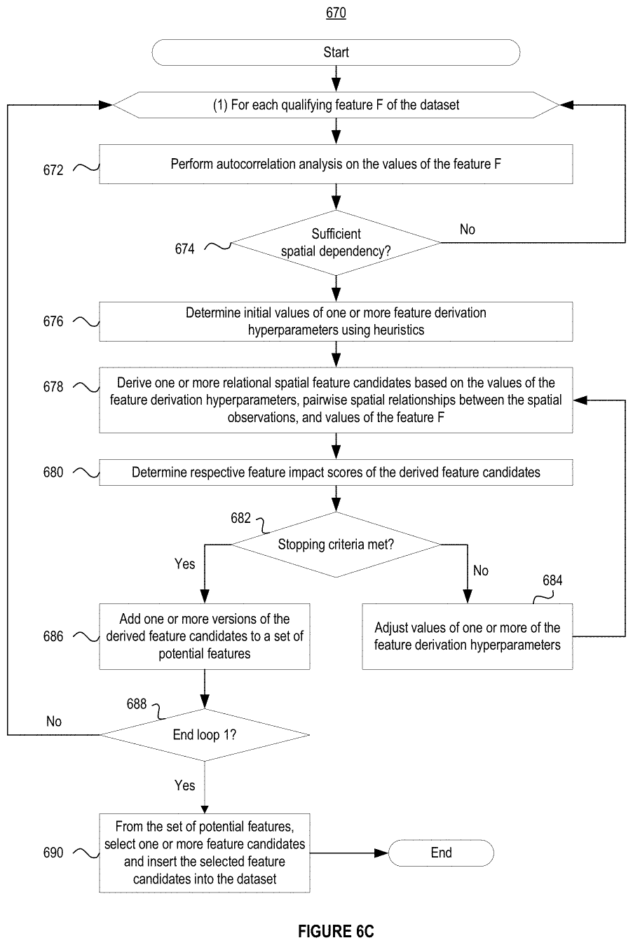

In many fields of spatial data analytics, the performance of spatial models can be enhanced by expanding the underlying datasets to include derived spatial features. Referring to FIG. 6A, a spatial feature engineering module 600 may perform automated spatial feature engineering to derive such spatial features from other spatial features, alone or in combination with non-spatial features (e.g., numeric features, categorical features, image features, etc.). For example, the spatial feature engineering module may use automated spatial feature engineering techniques to derive “solitary spatial features” and/or “relational spatial features” from a dataset, as described in further detail below. In some embodiments, the spatial feature engineering module 600 is a component of a feature engineering module 142.

In some embodiments, the spatial feature engineering module 600 includes a solitary spatial feature derivation module 610, a relational spatial feature derivation module 620, a relational spatial feature engineering controller 630, and a spatial feature selection module 640. The solitary spatial feature derivation module 610 may use automated spatial feature engineering techniques to derive “solitary spatial features” from spatial features of a dataset. The relational spatial feature derivation module 620 may use automated spatial feature engineering techniques to derive “relational spatial features” from spatial features and non-spatial features of a dataset. In some embodiments, the relational spatial feature engineering controller 630 controls the operation of the relational spatial feature derivation module 620 by setting the values of hyperparameters of the relational spatial feature engineering process. In some embodiments, the spatial feature selection module 640 selects one or more derived spatial feature candidates for inclusion in a dataset (e.g., modeling dataset 144 or refined modeling dataset 150). Such selection may be based, in part, on feature impact scores and/or feature importance scores of the derived feature candidates. Some embodiments of the spatial feature engineering module 600 and its components are described in further detail below.

As indicated above, the solitary spatial feature derivation module 610 may use automated spatial feature engineering techniques to derive “solitary spatial features” from spatial features of a dataset. Values of solitary spatial features represent geometric attributes and/or spatial statistics of individual (solitary) spatial objects, which may include one or more geometric elements. Some non-limiting examples of solitary spatial features that represent geometric attributes of a solitary spatial object may include the object's central tendency, properties relating to the object's magnitude (e.g., length, area, etc.), properties relating to the object's shape (e.g., elongation, aspect ratio, compactness, etc.), properties relating to the object's direction and/or orientation, etc. Some non-limiting examples of solitary spatial features that represent spatial statistics of a solitary spatial object may include standard distance (a measure of the degree to which a spatial object's geometric elements are concentrated or dispersed around the object's central tendency), standard deviational ellipse, etc. Some embodiments of techniques for deriving such features are described in more detail below. Use of solitary spatial features in the modeling process can greatly improve the performance of a model in scenarios where more naive representations of objects' spatial features are insufficient.

Likewise, the relational spatial feature derivation module 620 may use automated spatial feature engineering techniques to derive “relational spatial features” from spatial and non-spatial features of a dataset. In contrast to solitary spatial features, which are based on a spatial object's internal geometry, relational spatial features of a spatial object are based on the object's spatial relationships with other spatial objects in the dataset. Some non-limiting examples of relational spatial features may include spatial lags (first-order or higher order), local indicators of spatial autocorrelation, indicators of spatial cluster membership, indicators of hotspots or cold spots, etc. Some embodiments of techniques for deriving relational spatial features are described in more detail below. Use of relational spatial features in the modeling process can greatly improve the performance of a model in scenarios where one or more features of the dataset exhibit strong spatial autocorrelation or spatial dependency structures between observations (e.g., when values of a feature at an observation tend to be more similar to values of other nearby observations than to values of more distant observations).

The universe (“space”) of relational spatial feature candidates for a spatial dataset can be immense, and deriving the values of even a small fraction of the relational spatial feature candidates for a dataset can require significant computational resources. In some embodiments, the feature engineering process used by the relational spatial feature derivation module 620 to derive relational spatial feature candidates may be controlled by feature engineering hyperparameters, and the relational spatial feature engineering controller 630 may use hyperparameter optimization techniques to set the values of those hyperparameters, thereby guiding (e.g., optimizing) the process of automatically deriving and evaluating relational spatial feature candidates. For example, the relational spatial feature engineering controller 630 may use smart heuristics to initialize the hyperparameter values such that evaluation of relational spatial feature candidates begins in a region of the feature candidate space that is likely to provide useful feature candidates (e.g., feature candidates that are highly correlated with the dataset's target variable). Likewise, the relational spatial feature engineering controller 630 may iteratively adjust the hyperparameter values such that evaluation of relational spatial feature candidates efficiently converges upon the most useful feature candidates. Some embodiments of techniques for efficiently searching the space of relational spatial feature candidates for a spatial dataset are described in further detail below.

After multiple potentially useful spatial feature candidates are derived, the spatial feature selection module 640 may select a subset of the derived feature candidates for inclusion in the dataset. The remaining candidates may be discarded or retained for future use. In some embodiments, the spatial feature selection module 640 selects a set of derived feature candidates that (1) have high feature impact scores and/or feature importance scores and (2) are complementary (e.g., not highly correlated with each other, based on different features, based on different neighborhood constructions, based on different spatial lags, etc.).

Below, some examples of the operation of the spatial feature engineering module 600 in connection with the automated engineering of solitary spatial features and relational spatial features are described in more detail.

### Derivation of Solitary Spatial Feature Candidates

As indicated above, the solitary spatial feature derivation module 610 may use automated spatial feature engineering techniques to derive “solitary spatial features” from spatial features of a dataset. The use of solitary spatial features can greatly improve the accuracy of models in cases where a more naive representation of spatial objects is insufficient. In many spatial datasets, each spatial observation represents a spatial object as an individual point (e.g., a single location with no geometry), even if the spatial object being modeled (e.g., a property parcel or building) actually has more complex geometry (e.g., a polygon). The use of solitary spatial features that more richly convey the geometric properties of spatial objects can improve the accuracy of data analytics models by improving the models' capacity for understanding the relative sizes and shapes of spatial objects. As an example, the performance of a regression model that predicts the sale price of a single-family residential property based on a point location of the parcel can be greatly improved by expanding the dataset to include automatically derived features based on the area of the parcel and the residential structure.

As discussed above, a spatial observation can model an individual spatial object's geometry using one or more geometric elements (e.g., one or more points, lines (e.g., multilines), and/or polygons (e.g., multipolygons)). Based on a spatial object's geometric elements, some embodiments of the solitary spatial feature derivation module 610 may derive one or more solitary spatial features representing geometric properties of the spatial object as described below.
Central tendency: The solitary spatial feature derivation module 610 may derive a solitary spatial feature indicating a central tendency of a spatial object and/or central tendencies of one or more geometric elements associated with the spatial object. Some examples of techniques for determining the central tendency of a spatial object or geometric element(s) are described above with reference to step 340 of spatial feature extraction method 300.
Properties relating to length: The solitary spatial feature derivation module 610 may derive one or more solitary spatial features indicating the length of a spatial object and/or the lengths of one or more geometric elements associated with the spatial object, including, without limitation: lengths of one or more lines, line segments and/or curves of the spatial object; perimeters of polygon elements of the spatial object; the perimeter and/or dimensions of a minimum bounding box of the spatial object; perimeters and/or dimensions of minimum bounding boxes of the spatial object's individual geometric elements; and/or the dimensions of the shapes represented by the spatial object's polygon elements (e.g., major axis length, minor axis length, etc.). As used herein, the “minimum bounding box” of a spatial object or geometric element refers to the smallest rectangle (by area) or smallest right rectangular prism (by volume) that circumscribes the spatial object or geometric element.
Properties relating to area: The solitary spatial feature derivation module 610 may derive one or more solitary spatial features indicating the area of a spatial object and/or the areas of one or more geometric elements associated with the spatial object, including, without limitation: areas of polygon elements of the spatial object; the area of the minimum bounding box of the spatial object; and/or the areas of minimum bounding boxes of the spatial object's individual geometric elements.
Properties relating to shape: The solitary spatial feature derivation module 610 may derive one or more solitary spatial features indicating the shape of a spatial object and/or the shapes of one or more geometric elements associated with the spatial object, including, without limitation: the elongation, aspect ratio, compactness, eccentricity, ellipticity, circularity, roundness, sphericity, rectangularity, convexity, curl, convex hull, solidity, and/or form factor of the spatial object and/or its geometric elements. One of ordinary skill in the art will appreciate that the elongation of a non-curved geometric element is the ratio of the length of the element's minimum bounding box to the bounding box's width, the aspect ratio of a geometric element is the inverse of its width, and the compactness a geometric element is the ratio between the area of the element and the area of a circle having the same perimeter as the element.
Properties relating to direction or orientation: The solitary spatial feature derivation module 610 may derive one or more solitary spatial features indicating the direction (or orientation) of a spatial object and/or the directions (or orientations) of one or more geometric elements associated with the spatial object, including, without limitation: for a spatial object or geometric element having an elongated shape, the direction of the longer side of the minimum bounding box of the spatial object or geometric element; for a line segment, the direction of the line segment within a reference coordinate system or frame; and for a multiline feature, the linear directional mean.

Likewise, based on a spatial object's geometric elements, some embodiments of the solitary spatial feature derivation module 610 may derive one or more solitary spatial features representing spatial statistics (e.g., measures of geospatial distribution) of the spatial object. For example, the module 610 may derive a solitary spatial feature indicating the standard distance of a spatial object (a measure of the degree to which the object's geometric elements are concentrated or dispersed around the object's central tendency). As another example, the module 610 may derive a solitary spatial feature indicating the standard deviational ellipse of a spatial object.

One or more of the solitary spatial features derived by the solitary spatial feature derivation module 610 may be added to a dataset for downstream modeling. In some embodiments, the spatial feature selection module 640 determines which (if any) derived solitary spatial features are added to the dataset. The operation of the spatial feature selection module 640 is described in further detail below.

One of ordinary skill in the art will appreciate that many of the solitary spatial features described herein are not meaningful as applied to a spatial object that consists of a single point element. Accordingly, some embodiments of the solitary spatial feature deviation module 610 may not attempt to derive such solitary spatial features of such spatial objects.

### Derivation of Relational Spatial Feature Candidates

As indicated above, the relational spatial feature derivation module 620 may use automated spatial feature engineering techniques to derive “relational spatial features” of spatial objects based on the respective objects' spatial relationships with other spatial objects in the dataset. Relational spatial feature engineering may be particularly beneficial when one or more features (e.g., non-spatial features) of a dataset exhibit strong spatial autocorrelation or spatial dependency structures among observations (e.g., when the value of a feature for a given observation tends to be more similar to values of the feature for nearby observations, in contrast to values of the feature for more distant observations). For example, the market value of a single-family residential home is often closely related to recent sale prices of nearby homes (typically known as “comps” or “comparison sales”). For a machine learning model of residential home values, relational spatial feature derivation can capture the above-described relationships and thereby improve model performance. More generally, the benefits of relational spatial feature engineering may include, without limitation, (1) greatly improved model performance (e.g., accuracy) when spatial dependency structures are present in the dataset; (2) the ability to present distance decay of features and/or present directional effects to downstream automated machine learning tools; and/or (3) the ability to detect localized clustering within the context of the dataset.

The relational spatial feature derivation module 620 may be capable of deriving a variety of relational spatial features based on (1) the spatial relationships among a dataset's spatial observations, and (2) the values of one or more of the dataset's non-spatial features. Without limitation, these relational spatial features may include first-order and higher-order spatial lags of any of a dataset's features; local indicators of spatial autocorrelation (LISA) in the values of any of the dataset's features; spatial cluster membership of spatial observations when clustered based on their locations and on the values of any of the dataset's features; and/or significance scores (e.g., p-values or pseudo significance scores) associated with any of the dataset's features, where the significance score associated with a given feature of a spatial observation indicates the probability that the local spatial pattern of the values of that feature is random.

Any suitable techniques may be used to determine the values of the above-mentioned relational spatial features. In general, determining the value V of a relational spatial feature RSF for a spatial observation O involves (1) identifying a subset of the dataset's spatial observations as neighbors of observation O (for purposes of determining the value V of the feature RSF) based on the spatial relationships between observation O and the other observations in the dataset; and (2) calculating the value of the feature RSF for observation O based on the values of one or more features F of the neighbor observations. Optionally, the calculation of the value of the feature RSF for observation O may also be based on the spatial relationships between the observation O and its neighbors. For example, the calculation may be a weighted function of the values of the neighbors' feature(s) F, and the weight applied to the value contributed by each neighbor may depend on the neighbor's spatial relationship to the observation O.

Any suitable technique may be used to identify the neighbors of a spatial observation SO. In general, a spatial observation's neighbors are identified by (1) selecting a type of spatial relationship (e.g., fixed distance; inverse distance, rook-, bishop-, or queen-type distance, travel time, contiguity, etc.), (2) calculating the pairwise ‘distance’ between the spatial observation's representative location and the representative locations of the other observations in the dataset, where the ‘distance’ between two locations is a function of the locations and the selected type of spatial relationship, and where the distances may be represented in a distance matrix or ‘weights’ matrix, (3) selecting a type of spatial neighborhood function (e.g., k-nearest neighbors, spatial kernel smoothing, various forms of adjacency, etc.), (4) specifying a constraint on the size of the spatial neighborhood (e.g., number of neighbors, distance value that defines a distance-based neighborhood, etc.), and (5) applying the selected neighborhood function to the pairwise distances between the observation SO and the other observations in the dataset, subject to the specified constraint on the size of the neighborhood, to identify the neighbors of the spatial observation SO.

As the foregoing discussion indicates, the process of identifying the neighbors of a spatial observation is parameterizable. The hyperparameters of the neighborhood identification process may include the type of spatial relationship that defines the distance between locations, the type of spatial neighborhood function that defines the neighbor relationship, and the constraint(s) on the size of the spatial neighborhood. Furthermore, there may be additional hyperparameters associated with some of the relational spatial features. For example, in the process used to derive spatial lags, the order (m) of the spatial lag may be a hyperparameter of the process. In some embodiments, the values of these relational spatial feature engineering hyperparameters may be set by the relational spatial feature engineering controller 630 using any suitable techniques, including (without limitation) the techniques described in further detail below.

As discussed above, multiple types of relational spatial features (e.g., spatial lags, local indicators of spatial autocorrelation, etc.) can be derived for each non-spatial feature in the dataset. In addition, many variants or versions of each type of relational spatial feature can be derived, because the processes used to derive the values of the relational spatial features are parameterized. Each unique combination of values of the relational spatial feature engineering hyperparameters corresponds to a different version or variant of a derived relational spatial feature.

The values of the various relational spatial features (RSF) may be calculated using any suitable techniques and used for any suitable purpose. In some embodiments, spatial lag values may be standardized so that comparison of lag values across observations is not influenced by some observations simply having more neighbors than others. Such standardization can be important when neighborhoods are defined based on adjacency or distance. In some embodiments, spatial lags are calculated for non-numeric features (e.g., categorical features) by taking a weighted mode of the values of those non-numeric features. In some embodiments, local indicators of spatial autocorrelation may include local variants of Moran's I, Geary's C, or Getis's G. In some embodiments, the spatial cluster membership feature is derived by running a clustering algorithm on an observation and its neighbors, assigning each cluster a categorical or numeric identifier, and setting the value of the spatial cluster membership feature for each observation to the cluster identifier of the observation's cluster. In some embodiments, a pseudo significance score is similar to a p-value, but is calculated using random simulations to compare the observed pattern in the dataset to the random permutations. Together, the significance score and the local indicator of spatial autocorrelation may be used to identify hotspots and cold spots.

One or more of the relational spatial features derived by the relational spatial feature derivation module 620 may be added to a dataset for downstream modeling. In some embodiments, the spatial feature selection module 640 determines which (if any) derived relational spatial features are added to the dataset. The operation of the spatial feature selection module 640 is described in further detail below.

Referring to FIG. 6B, a relational spatial feature engineering method 650 is shown. The method 650 may be used to automatically derive relational spatial features (e.g., spatial lags) of a dataset's spatial observations based on spatial relationships between observations. Such derived features may be added to the observations prior to training a model on the dataset or prior to applying a trained model to the dataset to estimate the value of a target variable.

The relational spatial feature engineering method 650 may include steps of obtaining (651) a first dataset of spatial observations including respective values of a location feature; for each pair of the spatial observations, determining (652) a respective pairwise distance between the pair of spatial observations based on the values of the location features of the pair of spatial observations; for each of the spatial observations, identifying (653) a set of neighboring observations among the plurality of spatial observations by applying a neighborhood function to the pairwise distances associated with the respective spatial observation; for each of the spatial observations, determining (654) a respective value of a relational spatial feature based on values of one or more features of the neighboring observations of the respective spatial observation; and inserting (655) the values of the relational spatial feature into the respective spatial observations. Some embodiments of the steps 651-655 of the relational spatial feature engineering method 650 are described in further detail below.

In step 651, the relational spatial feature derivation module 620 obtains a dataset of spatial observations. The dataset may be, for example, the processed modeling data 130 provided by the feature extraction modules (122, 124) of a model development system 100, the processed inference data 830 provided by the feature extraction modules (822, 824) of a model deployment system 800, or the modeling data 144 of a data preparation and feature engineering module 140. Each of the spatial observations may include (1) a value of a location feature indicating a set of coordinates of a representative location of a respective spatial object, and (2) respective values of one or more other features. In some cases, the spatial observations may also include respective values of a target variable.

In step 652, for each pair of spatial observations in the dataset, the relational spatial feature derivation module 620 determines the pairwise ‘distance’ between the pair of spatial observations. The ‘distance’ between two observations may be any suitable function of the representative locations of the observations, and the function used to determine the distance may correspond to a particular type of spatial relationship.

In step 653, for each of the spatial observations in the dataset, the relational spatial feature derivation module 620 identifies a set of neighboring observations among the other spatial observations in the dataset by applying a neighborhood function to the pairwise distances associated with the respective spatial observation. Any suitable neighborhood function may be used, including (without limitation) a K-nearest neighbors neighborhood constructor, a spatial kernel neighborhood constructor, a spatial adjacency neighborhood constructor, etc. In some cases, one or more of the spatial observations may have no neighbors and, therefore, the corresponding set of neighboring observations may be empty.

In step 654, for each of the spatial observations in the dataset, the relational spatial feature derivation module 620 determines a value of a relational spatial feature based on values of one or more features of the respective observation's neighboring observations. Any suitable type of relational spatial feature may be used, including (without limitation) a spatial lag, a local indicator of spatial autocorrelation, etc. The value of the relational spatial feature may depend on the value(s) of any suitable feature(s) of the neighboring observations. In some cases, the value of the relational spatial feature may also depend on the pairwise ‘distances’ between the observation and the neighboring observations.

In step 655, the relational spatial feature derivation module 620 adds the relational spatial feature to the dataset and inserts the values of the relational spatial feature into the respective spatial observations.

### Controlling the Relational Spatial Feature Engineering Process

As discussed above, the universe (“space”) of relational spatial feature candidates for a spatial dataset can be immense, and deriving the values of even a small fraction of the relational spatial feature candidates for a dataset can require significant computational resources. For example, deriving spatially lagged variables is computationally expensive, and it can be very challenging to identify a ‘proper neighborhood’ for a spatial lag calculation. (In this context, a ‘proper neighborhood’ may be a neighborhood that maximally exposes local spatial dependence structures or local spatial autocorrelation for the feature in question across the entire dataset.) In some embodiments, the feature engineering process used by the relational spatial feature derivation module 620 to derive relational spatial feature candidates may be controlled by feature engineering hyperparameters, and the relational spatial feature engineering controller 630 may use hyperparameter optimization techniques to set the values of those hyperparameters, thereby guiding (e.g., optimizing) the process of automatically deriving and evaluating relational spatial feature candidates. Some examples of relational spatial feature engineering hyperparameters are described above (e.g., hyperparameters that control the sizes of spatial neighborhoods and the orders of spatial lags). Using hyperparameter optimization techniques to set the values of such hyperparameters may facilitate the discovery of spatial relationships, dependency structures, and/or autocorrelation patterns at varying distances for a broad range of training data and problem sets with no a priori knowledge of the spatial patterns for a given context. In this way, the feature engineering controller 630 may help the spatial feature engineering module 600 efficiently search the space of relational spatial feature candidates, such that search efficiently converges upon the most useful feature candidates (e.g., the candidates with the highest feature impact scores and/or feature importance scores).

In some embodiments, the relational spatial feature engineering controller 630 uses hyperparameter optimization techniques (e.g., grid search, gradient descent, etc.) to adjust the values of the hyperparameters during an iterative search of the space of relational spatial feature candidates so that this space is searched systematically and the optimal relational spatial feature candidates are identified efficiently. This approach tends to strike a good balance between the computational efficiency of the model development process and the performance of the models developed thereby.

In some embodiments, the relational spatial feature engineering controller 630 may use smart heuristics to initialize the hyperparameter values such that evaluation of relational spatial feature candidates begins in a region of the feature candidate space that is likely to provide useful feature candidates (e.g., feature candidates that have high feature impact scores and/or high feature importance scores). Some non-limiting examples of such heuristics are described below:
Prior to deriving relational spatial feature candidates based on a given feature F of the dataset, perform spatial autocorrelation analysis with respect to the values of the feature F. If the feature F does not exhibit significant global or local spatial autocorrelation (e.g., the values of one or more local or global indicators of spatial autocorrelation for the feature F fail to meet corresponding significance thresholds), the relational spatial feature engineering controller 630 may direct the relational spatial feature derivation module 620 to forego derivation of relational spatial feature candidates based on the feature F.
In cases where a spatial kernel neighborhood constructor is used to identify the neighbors of a spatial observation during the derivation of a relational spatial feature candidate based on a given feature F of the dataset, the relational spatial feature engineering controller 630 may set the initial shape of the spatial kernel based on anisotrophy or directional effects detected in the values of the feature F. For example, the controller 630 may set the initial shape of the spatial kernel to be elongated in the direction where the anisotrophy or directional effect is most prominent.
In cases where (i) a distance-based neighborhood constructor is used to identify the neighbors of a spatial observation during the derivation of a relational spatial feature candidate based on a given feature F of the dataset, and (ii) the dataset has been spatially partitioned using the spatial partitioning method 400 of FIG. 4A, the relational spatial feature engineering controller 630 may initialize the size of the neighborhood based on characteristics of the spatial blocking scheme. Such characteristics of the spatial blocking scheme may include, without limitation, the size of the spatial blocks, the mean number of observations per spatial block, the variance in the number of observations per spatial block, the distance D_{N} (e.g., the minimum distance D_{N}) at which the level of spatial autocorrelation (the “neighborhood effect”) for the feature F is sufficiently small, etc.

Referring to FIG. 6C, a relational spatial feature engineering method 670 is shown. The relational spatial feature engineering controller 630 may perform the method 670 to efficiently search the space of relational spatial feature candidates, such that search efficiently converges upon the most useful feature candidates (e.g., the candidates with the highest feature impact scores and/or feature importance scores). Such feature candidates may be added to the observations prior to training a model on the dataset. During performance of the method 670, hyperparameter optimization techniques may be used to optimize the values of spatial feature engineering hyperparameters (e.g., hyperparameters related to the size of spatial neighborhoods, the order of spatially lagged variables, etc.). Some embodiments of the steps 672-690 of the method 670 are described below.

As shown in FIG. 6C, steps 672-688 of the feature engineering method 670 may be performed for each qualifying feature F of a dataset. The qualifying features of the dataset may include all features of the dataset, all features of the dataset other than location features, all numeric features of the dataset, all numeric and/or categorical features of the dataset, or any other suitable subset of features of the dataset. For simplicity, the following paragraphs describe steps 672-688 with reference to a single feature F of the dataset. However, one of ordinary skill in the art will appreciate that the set of steps 672-688 may be performed iteratively or in parallel for the qualifying features of the dataset.

In step 672, spatial autocorrelation analysis is performed on the values of the feature F. Some techniques for performing spatial autocorrelation analysis are described above. In step 674, the controller 630 determines whether the values of the feature F exhibit sufficient spatial dependency (e.g., whether the values of one or more global or local indicators of spatial autocorrelation exceed a corresponding significance threshold). If so, the feature F is a candidate for relational spatial feature derivation. Otherwise, the feature F is not a candidate.

At step 676, the controller 630 determines the initial values of one or more relational spatial feature derivation hyperparameters. Some examples of relational spatial feature derivation hyperparameters are described above. The initial values of the hyperparameters may be determined using one or more heuristics. Some examples of such heuristics are described above.

At step 678, the relational spatial feature derivation module 620 derives one or more relational spatial feature candidates based on the values of the feature derivation hyperparameters, the pairwise spatial relationships between the spatial observations in the dataset, and the values of the feature F. Some examples of techniques for deriving relational spatial feature candidates are described above.

At step 680, feature impact scores of the derived feature candidates are determined. Some examples of techniques for determining feature impact scores are described above. In some embodiments, the feature importance scores of the derived feature candidates may also be determined.

At step 682, the controller 630 determines whether one or more stopping criteria are met. Any suitable stopping criteria may be used. In some embodiments, the stopping criteria are met if (1) an amount of time allocated to deriving features from feature F has elapsed, (2) an amount of computational resources allocated to deriving features from feature F has been expended, (3) one or more derived feature candidates having feature impact scores and/or feature importance scores greater than a corresponding threshold score have been identified, or (4) the outputs of the hyperparameter optimization process indicate that the optimal derived spatial feature candidates based on the feature F have already been derived.

If the stopping criteria are not met, at step 684, the values of one or more of the feature derivation hyperparameters are adjusted in accordance with the hyperparameter optimization process, and flow of control returns to step 678. If the stopping criteria are met, at step 686, one or more versions of the feature candidates derived from feature F are added to a set of potential features. The selected version(s) of the feature candidates may be selected based on their feature impact scores and/or feature importance scores. In some embodiments, the selected set of derived feature candidates (1) have high feature impact scores and/or feature importance scores and (2) are complementary (e.g., not highly correlated with each other, have different feature types (e.g., spatially lagged variables vs. local indicators of spatial autocorrelation), are based on different neighborhood constructions, are based on different spatial lags, are based on spatial lags of different orders, etc.).

When all qualifying features have been processed (step 688), flow of control proceeds to step 690. In step 690, one or more feature candidates are selected from the set of potential features and inserted into the dataset. Some techniques for performing such feature selection are described below.

### Spatial Feature Selection

In some embodiments, the spatial feature selection module 640 selects one or more derived spatial feature candidates from a set of potential features for inclusion in a dataset (e.g., modeling dataset 144 or refined modeling dataset 150). Such selection may be based, in part, on feature impact scores and/or feature importance scores of the derived feature candidates. In some embodiments, the selected set of derived feature candidates (1) have high feature impact scores and/or feature importance scores and (2) are complementary (e.g., not highly correlated with each other, have different feature types (e.g., spatially lagged variables vs. local indicators of spatial autocorrelation), are derived from different ‘parent’ features, are based on different neighborhood constructions, are based on different spatial lags, are based on spatial lags of different orders, etc.). In some embodiments, the spatial feature selection module 640 uses a random forest-based model (e.g., xgboost, an intermediate random forest-based feature importance reducer, etc.) to identify and discard redundant and correlated feature candidates.

### Image Feature Importance

### Univariate Feature Importance of Non-Tabular (e.g., Image) Features

In some embodiments, the univariate feature importance of non-tabular features (e.g., image features) may be determined using the Alternating Conditional Expectations (ACE) algorithm, treating the constituent features of a non-tabular data element (e.g., an image) as a single, aggregate feature. The ACE algorithm, which is based on L. Breiman et al., “Estimating Optimal Transformations for Multiple Regression and Correlation,” Journal of the American Statistical Association (1985), pp. 580-598, estimates the correlation between a target and one feature (e.g., a set of constituent image features treated as an aggregate image feature).

In some embodiments, the univariate feature importance of an aggregate non-tabular feature F_{A} (e.g., image feature vector) is estimated by (1) extracting a set of one or more constituent features F_{C} (e.g., constituent image features) from each instance of the non-tabular data element (e.g., image) in a dataset (e.g., a training dataset), (2) determining independent ACE scores for each of the constituent features F_{C}, (3) optionally normalizing the individual ACE scores of the features F_{C}, and (4) determining the feature importance of the aggregate feature F_{A} based on the (optionally normalized) ACE scores of the constituent features F_{C}. Any suitable technique may be used to determine the feature importance of the aggregate feature F_{A} including, without limitation, selecting the maximum normalized ACE score of the set of constituent features F_{C} as the feature importance of the aggregate non-tabular feature F_{A}, using the mean or median of the N highest ACE scores of the set of constituent features F_{C} as the feature importance of the aggregate non-tabular feature F_{A}, where N is any suitable positive integer (e.g., 3, 5, 10, 20, 50, 100, etc.). The constituent features F_{C} of the non-tabular data elements (e.g., images) may be extracted, for example, using feature extraction models (e.g., image feature extraction models).

Any suitable set of constituent features extracted from the non-tabular data elements of a group of data samples by a feature extraction model may be used to calculate the aggregate feature importance of an aggregate non-tabular feature. For example, the set of features used to calculate the feature importance of a non-tabular feature may be or include (i) all extracted features, all low-level features, all medium-level features, all high-level features, all highest level features, all globally pooled outputs of the last convolutional neural network layer in the CNN of a feature extraction model, or any suitable combination of the foregoing.

The ACE scores determined for each of the constituent features F_{C} may be individually and independently normalized against the target feature based on the project metric (for example, to account for the Gini Norm and Gamma Deviance metrics being on different scales). The normalization may be done relative to the target, since the target relative to itself has the largest ACE score. After normalization, the constituent feature F_{C} that contributes the highest score may be displayed or otherwise identified.

In some embodiments, the univariate feature importance values determined for various features (e.g., features of the same type, features of different types, tabular features, non-tabular features, image features, non-image features, etc.) can be quantitatively compared to each other. This comparison may help the user understand the importance of including various non-tabular data elements (e.g., images) in the dataset.

In some embodiments, the feature importance module 141 may determine ACE scores for each of the constituent features F_{C} (e.g., constituent image features) extracted from a column of non-tabular data elements (e.g., images) by a feature extraction model (e.g., an image feature extraction model), and may concatenate those ACE scores to form a non-tabular (e.g., image) feature importance vector. The ordering of the feature importance elements in the non-tabular (e.g., image) feature importance vector may match the ordering of the constituent features (e.g., constituent image features) in the non-tabular (e.g., image) feature vector. Such feature importance vectors may be used to generate image inference explanations.

### Feature Impact of Non-Tabular (e.g., Image) Features

In some embodiments, the following process may be used to determine the feature impact of a non-tabular feature F for a trained model M: (1) use the model M to generate a set of inferences INF1 for a validation dataset V in which the data samples contain the actual values of all the model's features, and score the model's performance P1 based on the inferences INF1 using any suitable performance metric (e.g., accuracy); (2) generate a modified version of the validation dataset V′ in which the predictive value of the feature F has been destroyed (e.g., by shuffling the values of the feature F across the data samples in V′, by storing the same value of the feature F in each of the data samples in V′, etc.); (3) use the model M to generate a set of inferences INF2 for the dataset V′, and score the model's performance P2 based on the inferences INF2 using the same performance metric; and (4) determine the feature impact F_{IMP} of the feature F for the model M based on the difference between the performance scores P1 and P2 (e.g., F_{IMP}=P1−P2, F_{IMP}=(P1−P2)/P1, etc.).

### Model Development Method

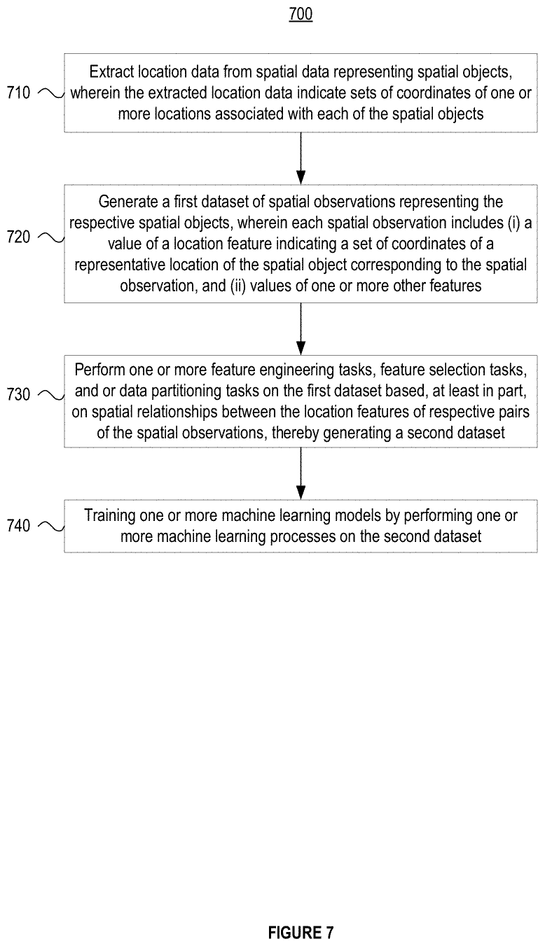

Referring to FIG. 7, a model development method 700 may include steps of extracting (710) location data from spatial data representing spatial objects, wherein the extracted location data indicate one or more sets of coordinates of one or more locations associated with each of the spatial objects; generating (720) a first dataset comprising spatial observations representing the respective spatial objects, wherein each spatial observation includes (i) a value of a location feature indicating a set of coordinates of a representative location of the spatial object corresponding to the spatial observation, and (ii) values of one or more other features; performing (730) one or more feature engineering tasks, feature selection tasks, and or data partitioning tasks on the first dataset based, at least in part, on spatial relationships between the location features of respective pairs of the spatial observations, thereby generating a second dataset; and training (740) one or more machine learning models by performing one or more machine learning processes on the second dataset. In some embodiments, the model development method 700 is a method for automated development of spatially-aware data analytics models (e.g., machine learning models). Some embodiments of the steps of the method 700 are described in further detail below.

In some embodiments, for each of the spatial objects, the one or more locations associated with the respective spatial object comprise one or more locations of one or more geometric elements of the respective spatial object. In some embodiments, the one or more geometric elements of the respective spatial object comprise one or more points, lines, curves, and/or polygons of the respective spatial object.

In some embodiments, for each of the spatial objects, the representative location of the respective spatial object is a location of a central tendency of the respective spatial object. In some embodiments, the method 700 further includes, for each of the spatial objects, determining the location of the central tendency of the spatial object based, at least in part, on the one or more sets of coordinates of the one or more locations associated with the respective spatial object. Some examples of techniques for determining the location of the central tendency of a spatial object are described above.

In some embodiments, a data partitioning task is performed. The data partitioning task may include spatially partitioning the plurality of spatial observations based on spatial relationships between the location features of respective pairs of the spatial observations. Spatially partitioning the plurality of spatial observations may include performing spatial autocorrelation analysis on the spatial observations; based on the spatial autocorrelation analysis, determining a distance at a neighborhood effect for the plurality of spatial observations satisfies one or more neighborhood effect criteria; based on the distance, determining one or more characteristics of a spatial block for tessellation of a spatial region over which the spatial observations are dispersed; generating a tessellation of the spatial region, the tessellation comprising a plurality of instances of the spatial block, wherein each of the spatial observations is associated with the respective instance of the spatial block in which the coordinates of the location feature of the spatial observation are located; and partitioning the spatial observations among a plurality of data partitions, wherein the respective data partition to which each of the spatial observations is assigned is determined based on which instance of the spatial block is associated with the respective spatial observation. Some examples of techniques for partitioning spatial data are described above.

In some embodiments, a feature selection task is performed. The feature selection task may include assessing a feature importance of the location feature for a first model included in the one or more machine learning models. In some embodiments, assessing the feature importance of the location feature for the first model comprises obtaining a test dataset comprising a plurality of test observations representing a respective plurality of spatial objects, wherein each test observation includes (1) a respective value of the location feature indicating a set of coordinates of a representative location of the spatial object corresponding to the test observation, (2) respective values of one or more other features, and (3) a respective value of a target variable; determining a first score characterizing a performance of the first model when tested on the test dataset; permuting the values of the location feature of the test observations across the test observations, thereby generating a retest dataset; determining a second score characterizing a performance of the first model when tested on the retest dataset; and determining a third score indicating a feature importance of the location feature based on the first and second scores. Some examples of techniques for determining the feature importance of location features are described above.

In some embodiments, a solitary spatial feature engineering task is performed. The method 700 may further include extracting geometric data from the spatial data, wherein the extracted geometric data characterize one or more geometric elements of each of the spatial objects. Performing the solitary spatial feature engineering task may include deriving a respective value of a solitary spatial feature based on a portion of the extracted geometric data characterizing the geometric elements of the spatial object represented by the spatial observation, and inserting the respective value of the solitary spatial feature in the spatial observation. Some examples of techniques for deriving solitary spatial features are described above.

In some embodiments, a relational spatial feature engineering task is performed. Performing the relational spatial feature engineering task may include deriving a plurality of values of a relational spatial feature based on pairwise spatial relationships between the spatial observations; and inserting the values of the relational spatial feature into the respective spatial observations, thereby generating the second dataset. In some embodiments, deriving the values of the relational spatial feature comprises, for each pair of the spatial observations, determining a respective pairwise distance between the pair of spatial observations based on the values of the location features of the pair of spatial observations; for each of the spatial observations, identifying a set of neighboring observations among the plurality of spatial observations by applying a neighborhood function to the pairwise distances associated with the respective spatial observation; and for each of the spatial observations, determining the respective value of the relational spatial feature based on values of one or more features of the neighboring observations of the respective spatial observation. In some embodiments, performing the relational spatial feature engineering task may include performing the feature engineering method 670.

### Model Deployment System

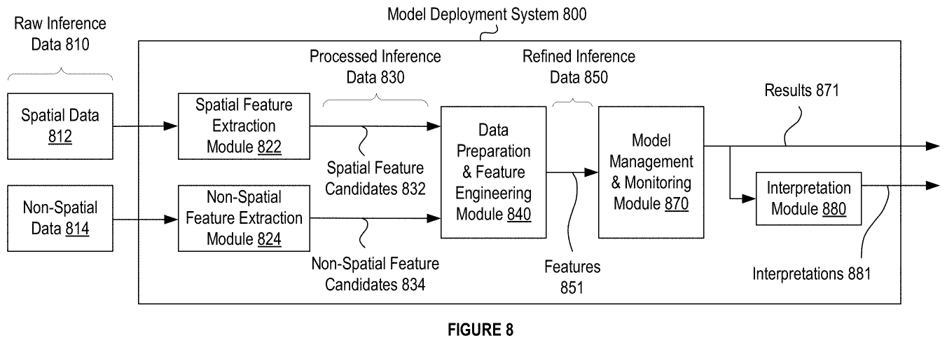

Referring to FIG. 8, a data analytics model deployment system 800 may include a spatial feature extraction module 822, a non-spatial feature extraction module 824, a data preparation and feature engineering module 840, a model management and monitoring module 870, and an interpretation module 880. In some embodiments, the model deployment system 800 receives raw inference data 810 and processes it using one or more models (e.g., machine learning models, etc.) to solve a problem in a domain of spatial data analytics. The inference data 810 may include spatial data 812 (e.g., in vector format). Optionally, the inference data may also include non-spatial data 814 (e.g., image data, numeric data, categorical data, text data, etc.). Some embodiments of the components and functions of the model deployment system 800 are described in further detail below.

The spatial feature extraction module 822 may perform spatial data pre-processing and spatial feature extraction on the spatial data 812, and provide the extracted spatial features to the data preparation and feature engineering module 840 as spatial feature candidates 832 within a processed inference dataset 830. The extracted features may include, for example, the locations and optionally other attributes of spatial objects represented by the spatial data 812, the locations and optionally other attributes of the geometric elements of the spatial objects, etc. In some embodiments, the spatial feature extraction module 822 stores the extracted coordinates of each spatial object as related values of a “location feature” rather than storing the coordinates as independent values of unrelated numeric features. Any suitable techniques may be used to extract spatial features from the spatial data 812. Some embodiments of suitable techniques for extracting spatial feature candidates are described above with reference to spatial feature extraction module 122.

Optionally, the model deployment system 800 may include a non-spatial feature extraction module 824, which may extract one or more non-spatial features from the raw inference data 810. For example, the raw inference data 810 may include image data, and the non-spatial feature extraction module 824 may include a computer vision module that performs one or more computer vision functions on the image data. In some embodiments, the computer vision module performs image pre-processing and feature extraction on the image data, and provides the extracted features to the data preparation and feature engineering module 840 as image feature candidates within the processed inference dataset 830. Some embodiments of suitable techniques for extracting image feature candidates are described above with reference to non-spatial feature extraction module 824.

In the example of FIG. 8, the spatial feature extraction module 822 and the non-spatial feature extraction module 824 are shown as separate modules. In some embodiments, the feature extraction modules (822, 824) may be integrated.

The data preparation and feature engineering module 840 may perform data preparation and/or feature engineering operations on the processed inference data 830. Some embodiments of suitable techniques for performing data preparation and feature engineering operations are described above with reference to data preparation and feature engineering module 140.

The model management and monitoring module 870 may manage the application of a deployed model to the features 851 of the refined inference data 850, thereby solving the data analytics problem and producing results 871 characterizing the solution. In some embodiments, the model management and monitoring module 870 may track changes in data (including image data and/or spatial data) over time (e.g., data drift) and warn the user if excessive data drift is detected. In addition, the model management and monitoring module 870 may be capable of retraining a deployed model (e.g., rerunning the model blueprint on new training data) and/or replacing a deployed model with another model (e.g., the retrained model). Retraining and/or replacement of a deployed model may be manually initiated by the user (e.g., in response to receiving a warning that excessive data drift has been detected) or automatically initiated by the model management and monitoring module 870 (e.g., in response to detecting excessive data drift).

In some embodiments, the model management and monitoring module 870 can assess the inference non-spatial data 814 (e.g., image data) for changes and deviation from the training non-spatial data 114 (e.g., from earlier-provided training image data) over time. To detect any changes or drift in the non-spatial data 814 (e.g., image data), the model management and monitoring module 870 may individually assess the non-spatial feature candidates (e.g., image feature candidates) extracted from the non-spatial data 814 using (1) a specified binning strategy and drift metric for that image feature and/or (2) anomaly detection. The binning strategies available for use may include, without limitation, fixed width, fixed frequency, Freedman-Diaconis, Bayesian Blocks, decile, quartile, and/or other quantiles. Available drift metrics may include, without limitation, Population Stability Index (PSI), Hellinger distance, Wasserstein distance, Kolmogorov-Smirnov test, Kullback-Leibler Divergence, Histogram intersection, and/or other drift metrics (e.g., user-supplied or custom metrics).

In some embodiments, the model management and monitoring module 870 may present (e.g., display) evaluations of models to users. Such model evaluations may include feature importance scores of one or more features for one or more models. Presenting the feature importance scores to the user may assist the user in understanding the relative performance of the evaluated models. For example, based on the presented feature importance scores, the user (or the system) may identify a top model M that is outperforming the other top models, and one or more features F that are important to the model M but not to the other top models. The user may conclude (or the system may indicate) that, relative to the other top models, the model M is making better use of the information represented by the features F.

The interpretation module 880 may interpret the relationships between the results 871 (e.g., predictions) provided by the model deployment system 800 and the portions of the inference data (e.g., spatial data and/or non-spatial data) on which those results 871 are based, and may provide interpretations (or “explanations”) 881 of those relationships.

In some embodiments, the interpretation module 880 may provide one or more of the following types of interpretations:

1. Feature importance. By deriving feature candidates from spatial data and non-spatial data and providing those feature candidates as inputs to data analytics models, some embodiments make it possible for the feature importance of spatial features and non-spatial features (e.g., image features) to be quantified using the same technique, and thereby make it possible for the feature importance of spatial features and non-spatial features to be directly compared. Some non-limiting examples of techniques for determining feature importance are described above with respect to univariate feature importance and feature impact.

2. Visual explanations of areas of interest in spatial data and non-spatial data. In some embodiments, the interpretation module 880 provides explanations of areas of interest in spatial data and non-spatial data (e.g., image data). For example, the interpretation module 880 may provide image inference explanation visualizations highlighting the regions of images that the model considers important for making inferences, regardless of the algorithmic nature of the data analytics model. For example, in some embodiments, the data analytics model for which visual image inference explanations are provided can be a deep learning model, while in other embodiments the data analytics model for which visual image inference explanations are provided is not a deep learning model. In other words, some embodiments may provide model-agnostic visual image inference explanations. Some non-limiting examples of techniques for visual image inference explanations are described above with respect to univariate feature importance and feature impact.

3. User interface tools for “drilling down” into specific model inferences. In some embodiments, the interpretation module 880 provides a user interface for drilling down into specific model inferences (e.g., erroneous model inferences). This user interface may enable the user to see the examples of spatial data or non-spatial data for which a specific target was predicted or for which the data sample had a specific ground truth value.

### Model Deployment Method

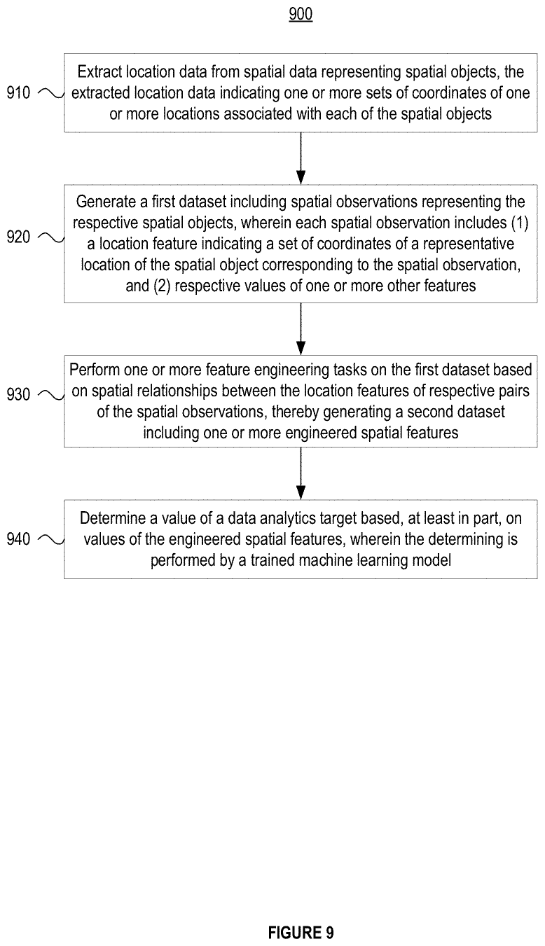

Referring to FIG. 9, a model deployment method 900 may include steps of extracting (910) location data from spatial data, the spatial data representing a plurality of spatial objects, the extracted location data indicating one or more sets of coordinates of one or more locations associated with each of the spatial objects; generating (920) a first dataset comprising a plurality of spatial observations representing the respective plurality of spatial objects, wherein each spatial observation includes (1) a location feature indicating a set of coordinates of a representative location of the spatial object corresponding to the spatial observation, and (2) respective values of one or more other features; performing (930) one or more feature engineering tasks on the first dataset based, at least in part, on spatial relationships between the location features of respective pairs of the spatial observations, thereby generating a second dataset including one or more engineered spatial features; and determining (940) a value of a data analytics target based, at least in part, on values of the engineered spatial features, wherein the determining is performed by a trained machine learning model. In some embodiments, the model development method 900 is a method for deployment of a spatially-aware data analytics model (e.g., machine learning model). Some embodiments of the steps of the method 900 are described in further detail below.

In some embodiments, for each of the spatial objects, the one or more locations associated with the respective spatial object comprise one or more locations of one or more geometric elements of the respective spatial object. In some embodiments, the one or more geometric elements of the respective spatial object comprise one or more points, lines, curves, and/or polygons of the respective spatial object.

In some embodiments, for each of the spatial objects, the representative location of the respective spatial object is a location of a central tendency of the respective spatial object. In some embodiments, the method 900 further includes, for each of the spatial objects, determining the location of the central tendency of the spatial object based, at least in part, on the one or more sets of coordinates of the one or more locations associated with the respective spatial object. Some examples of techniques for determining the location of the central tendency of a spatial object are described above.

In some embodiments, the method 900 further includes assessing a feature importance of the location feature for the trained model. In some embodiments, assessing the feature importance of the location feature for the trained model includes: obtaining a test dataset comprising a plurality of test observations representing a respective plurality of spatial objects, wherein each test observation includes (1) a respective value of the location feature indicating a set of coordinates of a representative location of the spatial object corresponding to the test observation, (2) respective values of one or more other features, and (3) a respective value of a target variable; determining a first score characterizing a performance of the trained model when tested on the test dataset; permuting the values of the location feature of the test observations across the test observations, thereby generating a retest dataset; determining a second score characterizing a performance of the trained model when tested on the retest dataset; and determining a third score indicating a feature importance of the location feature based on the first and second scores. Some examples of techniques for determining the feature importance of location features are described above.

In some embodiments, the method further includes extracting geometric data from the spatial data, the extracted geometric data characterizing one or more geometric elements of each of the spatial objects. In some embodiments, performing the one or more feature engineering tasks comprises performing a solitary spatial feature engineering task. In some embodiments, performing the solitary spatial feature engineering task includes, for each of the spatial observations, deriving respective values of one or more solitary spatial features based on a portion of the extracted geometric data characterizing the geometric elements of the spatial object represented by the spatial observation; and the engineered spatial features include the one or more solitary spatial features. Some examples of techniques for deriving solitary spatial features are described above.

In some embodiments, performing the one or more feature engineering tasks includes performing a relational spatial feature engineering task. In some embodiments, performing the relational spatial feature engineering task includes deriving a plurality of values of a relational spatial feature based on pairwise spatial relationships between the spatial observations; and inserting the values of the relational spatial feature into the respective spatial observations, thereby generating the second dataset. In some embodiments, deriving the values of the relational spatial feature includes: for each pair of the spatial observations, determining a respective pairwise distance between the pair of spatial observations based on the values of the location features of the pair of spatial observations; for each of the spatial observations, identifying a set of neighboring observations among the plurality of spatial observations by applying a neighborhood function to the pairwise distances associated with the respective spatial observation; and for each of the spatial observations, determining the respective value of the relational spatial feature based on values of one or more features of the neighboring observations of the respective spatial observation. Some examples of techniques for deriving solitary spatial features are described above.

### Further Description of Some Embodiments

Some examples have been described in which two-dimensional spatial data are analyzed, and the locations of spatial objects are represented by a coordinate pair. However, the techniques described herein are not limited to two-dimensional spatial data or two-dimensional locations. In some embodiments, three-dimensional spatial data are analyzed, and the locations of spatial objects are represented by three coordinates.

Some examples have been described in which the spatial feature engineering processes are parameterized, and hyperparameter optimization techniques are used to adjust the values of the spatial feature engineering hyperparameters during an iterative search of the space of derived spatial feature candidates. However, the techniques described herein for parameterizing feature engineering processes and using hyperparameter optimization techniques to adjust the values of those hyperparameters during an iterative search of a space of derived feature candidates are not limited to spatial feature engineering. These techniques can be applied to the engineering of other types of features, including image features, natural language features, text features, speech features, audio features, and/or time-series features.

The techniques described herein may be used to provide solutions to a wide variety of data analytics problems, including (without limitation), development and deployment of land cover classifiers; clustering; geographically weighted regression; digital mapping (e.g., automatically extracting road networks and building footprints from satellite imagery); forest fire prediction; crop disease detection; rooftop extraction; change detection; predictive asset allocation; predictive routing (e.g., of traffic); risk management; etc.

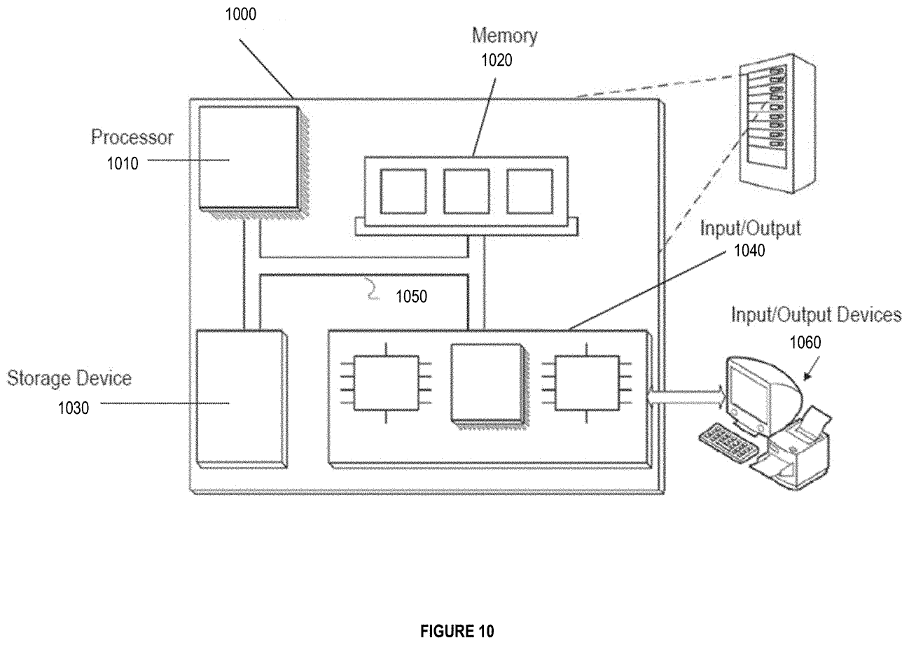

FIG. 10 is a block diagram of an example computer system 1000 that may be used in implementing the technology described in this document. General-purpose computers, network appliances, mobile devices, or other electronic systems may also include at least portions of the system 1000. The system 1000 includes a processor 1010, a memory 1020, a storage device 1030, and an input/output device 1040. Each of the components 1010, 1020, 1030, and 1040 may be interconnected, for example, using a system bus 1050. The processor 1010 is capable of processing instructions for execution within the system 1000. In some implementations, the processor 1010 is a single-threaded processor. In some implementations, the processor 1010 is a multi-threaded processor. The processor 1010 is capable of processing instructions stored in the memory 1020 or on the storage device 1030.

The memory 1020 stores information within the system 1000. In some implementations, the memory 1020 is a non-transitory computer-readable medium. In some implementations, the memory 1020 is a volatile memory unit. In some implementations, the memory 1020 is a nonvolatile memory unit.

The storage device 1030 is capable of providing mass storage for the system 1000. In some implementations, the storage device 1030 is a non-transitory computer-readable medium. In various different implementations, the storage device 1030 may include, for example, a hard disk device, an optical disk device, a solid-date drive, a flash drive, or some other large capacity storage device. For example, the storage device may store long-term data (e.g., database data, file system data, etc.). The input/output device 1040 provides input/output operations for the system 1000. In some implementations, the input/output device 1040 may include one or more of a network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 1060. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 1030 may be implemented in a distributed way over a network, for example as a server farm or a set of widely distributed servers, or may be implemented in a single computing device.

Although an example processing system has been described in FIG. 10, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, an engine, a pipeline, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein is for the purpose of description and should not be regarded as limiting.

Measurements, sizes, amounts, etc. may be presented herein in a range format. The description in range format is merely for convenience and brevity and should not be construed as an inflexible limitation on the scope of the claims. Accordingly, the description of a range should be considered to have specifically disclosed all the possible subranges as well as individual numerical values within that range. For example, description of a range such as 10-20 inches should be considered to have specifically disclosed subranges such as 10-11 inches, 10-12 inches, 10-13 inches, 10-14 inches, 11-12 inches, 11-13 inches, etc.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

Measurements, sizes, amounts, etc. may be presented herein in a range format. The description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as 10-20 inches should be considered to have specifically disclosed subranges such as 10-11 inches, 10-12 inches, 10-13 inches, 10-14 inches, 11-12 inches, 11-13 inches, etc.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

1. An automated, spatially-aware data analytics method, comprising:
extracting location data from spatial data, the spatial data representing a plurality of spatial objects, the extracted location data indicating one or more sets of coordinates of one or more locations associated with each of the spatial objects;
generating a first dataset comprising a plurality of spatial observations representing the respective plurality of spatial objects, wherein each spatial observation includes (1) a respective value of a location feature indicating a set of coordinates of a representative location of the spatial object corresponding to the spatial observation, and (2) respective values of one or more other features;
performing one or more feature engineering tasks, feature selection tasks, and or data partitioning tasks on the first dataset based, at least in part, on spatial relationships between the location features of respective pairs of the spatial observations, thereby generating a second dataset; and
training one or more machine learning models by performing one or more machine learning processes on the second dataset.

2-3. (canceled)

4. The method of claim 1, wherein for each of the spatial objects, the one or more locations associated with the respective spatial object comprise one or more locations of one or more geometric elements of the respective spatial object.

5. The method of claim 4, wherein the one or more geometric elements of the respective spatial object comprise one or more points, lines, curves, and/or polygons of the respective spatial object.

6. The method of claim 1, wherein, for each of the spatial objects, the representative location of the respective spatial object is a location of a central tendency of the respective spatial object.

7. The method of claim 6, further comprising, for each of the spatial objects:
determining the location of the central tendency of the spatial object based, at least in part, on the one or more sets of coordinates of the one or more locations associated with the respective spatial object.

8. (canceled)

9. The method of claim 1, wherein performing the one or more feature engineering tasks, feature selection tasks, and/or data partitioning tasks comprises spatially partitioning the plurality of spatial observations based on spatial relationships between the location features of respective pairs of the spatial observations.

10. The method of claim 9, wherein spatially partitioning the plurality of spatial observations comprises:
performing spatial autocorrelation analysis on the spatial observations;
based on the spatial autocorrelation analysis, determining a distance at a neighborhood effect for the plurality of spatial observations satisfies one or more neighborhood effect criteria;
based on the distance, determining one or more characteristics of a spatial block for tessellation of a spatial region over which the spatial observations are dispersed;
generating a tessellation of the spatial region, the tessellation comprising a plurality of instances of the spatial block, wherein each of the spatial observations is associated with the respective instance of the spatial block in which the coordinates of the location feature of the spatial observation are located; and
partitioning the spatial observations among a plurality of data partitions, wherein the respective data partition to which each of the spatial observations is assigned is determined based on which instance of the spatial block is associated with the respective spatial observation.

11. The method of claim 10, further comprising:
determining whether a distribution of the spatial observations among the data partitions satisfies one or more distribution criteria; and
if the distribution of the spatial observations does not satisfy the one or more distribution criteria, repartitioning the spatial observations among the plurality of data partitions.

12. The method of claim 10, further comprising:
determining whether a distribution of the spatial observations among the data partitions satisfies one or more distribution criteria; and
if the distribution of the spatial observations does not satisfy the one or more distribution criteria,
adjusting one or more characteristics of the spatial block, thereby generating an adjusted spatial block,
generating an adjusted tessellation of the spatial region comprising a plurality of instances of the adjusted spatial block, and
repartitioning the spatial observations among the plurality of data partitions based on the respective instances of the adjusted spatial blocks with which the spatial observations are associated.

13. The method of claim 10, further comprising:
generating a training dataset comprising the spatial observations assigned to a first subset of the data partitions; and
generating a testing dataset comprising the spatial observations assigned to a second subset of the data partitions.

14. The method of claim 13, wherein training the one or more machine learning models comprises training a first machine learning model by performing a first machine learning process on the training dataset.

15. The method of claim 14, further comprising testing the first machine learning model on the testing dataset.

16. The method of claim 1, wherein performing the one or more feature engineering tasks, feature selection tasks, and/or data partitioning tasks comprises assessing a feature importance of the location feature for a first model included in the one or more machine learning models.

17. The method of claim 16, wherein assessing the feature importance of the location feature for the first model comprises:
obtaining a test dataset comprising a plurality of test observations representing a respective plurality of spatial objects, wherein each test observation includes (1) a respective value of the location feature indicating a set of coordinates of a representative location of the spatial object corresponding to the test observation, (2) respective values of one or more other features, and (3) a respective value of a target variable;
determining a first score characterizing a performance of the first model when tested on the test dataset;
permuting the values of the location feature of the test observations across the test observations, thereby generating a retest dataset;
determining a second score characterizing a performance of the first model when tested on the retest dataset; and
determining a third score indicating a feature importance of the location feature based on the first and second scores.

18-19. (canceled)

20. The method of claim 17, further comprising performing at least one of the feature engineering tasks based, at least in part, on the third score indicating the feature importance of the location feature.

21-22. (canceled)

23. The method of claim 1, further comprising extracting geometric data from the spatial data, the extracted geometric data characterizing one or more geometric elements of each of the spatial objects.

24. The method of claim 23, wherein performing the one or more feature engineering tasks, feature selection tasks, and/or data partitioning tasks comprises, for each of the spatial observations, deriving a respective value of a solitary spatial feature based on a portion of the extracted geometric data characterizing the geometric elements of the spatial object represented by the spatial observation.

25. The method of claim 24, wherein the respective value of the solitary spatial feature of a particular spatial observation indicates a length, area, shape, or direction of the spatial object represented by the particular spatial observation.

26. The method of claim 24, wherein the respective value of the solitary spatial feature of a particular spatial observations indicates a length, area, shape, or direction of a geometric element of the spatial object represented by the particular spatial observation.

27. The method of claim 24, wherein the respective value of the solitary spatial feature of a particular spatial observation indicates a standard distance or a standard deviational ellipse of the spatial object represented by the particular spatial observation.

28. The method of claim 1, wherein performing the one or more feature engineering tasks, feature selection tasks, and/or data partitioning tasks comprises:
deriving a plurality of values of a relational spatial feature based on pairwise spatial relationships between the spatial observations; and
inserting the values of the relational spatial feature into the respective spatial observations, thereby generating the second dataset.

29. The method of claim 28, wherein deriving the values of the relational spatial feature comprises:
for each pair of the spatial observations, determining a respective pairwise distance between the pair of spatial observations based on the values of the location features of the pair of spatial observations;
for each of the spatial observations, identifying a set of neighboring observations among the plurality of spatial observations by applying a neighborhood function to the pairwise distances associated with the respective spatial observation; and
for each of the spatial observations, determining the respective value of the relational spatial feature based on values of one or more features of the neighboring observations of the respective spatial observation.

30. The method of claim 29, wherein the pairwise distance between the pair of spatial observations is a function of the values of the location features of the pair of spatial observations.

31. The method of claim 30, wherein the function corresponds to a particular type of spatial relationship.

32. The method of claim 29, wherein the set of neighboring observations for at least one of the spatial observations is empty.

33. The method of claim 29, wherein the relational spatial feature comprises a spatially lagged variable, a local indicator of spatial autocorrelation, an indication of spatial cluster membership, and/or a significance score.

34. The method of claim 29, wherein the respective value of the relational spatial feature is further based on the pairwise distances between the respective spatial observation and the neighboring observations of the respective spatial observation.

35-39. (canceled)

40. An automated, spatially-aware data partitioning method, comprising:
obtaining a dataset comprising a plurality of spatial observations, wherein each spatial observation includes (1) a respective value of a location feature indicating a set of coordinates of a representative location of a respective spatial object, (2) respective values of one or more other features, and (3) a respective value of a target variable;
performing spatial autocorrelation analysis on the values of the target variable of the spatial observations with respect to the coordinates of the location features of the spatial observations;
based on the spatial autocorrelation analysis, determining a distance at which a neighborhood effect for the plurality of spatial observations satisfies one or more neighborhood effect criteria;
based on the distance, determining one or more characteristics of a spatial block for tessellation of a spatial region over which the spatial observations are dispersed;
generating a tessellation of the spatial region, the tessellation comprising a plurality of instances of the spatial block, wherein each of the spatial observations is associated with the respective instance of the spatial block in which the coordinates of the location feature of the spatial observation are located; and
partitioning the spatial observations among a plurality of data partitions, wherein the respective data partition to which each of the spatial observations is assigned is determined based on which instance of the spatial block is associated with the respective spatial observation.

41-50. (canceled)

51. A spatially-aware feature importance assessment method, comprising:
obtaining a trained machine learning model and a first dataset comprising a plurality of spatial observations representing a respective plurality of spatial objects, wherein each spatial observation includes (1) a respective value of a location feature indicating a set of coordinates of a representative location of the spatial object corresponding to the spatial observation, (2) respective values of one or more other features, and (3) a respective value of a target variable;
determining a first score characterizing a performance of the trained model when tested on the first dataset;
permuting the values of the location feature across the spatial observations, thereby generating a second dataset;
determining a second score characterizing a performance of the first model when tested on the second dataset; and
determining a third score indicating a feature importance of the location feature based on the first and second scores.

52-56. (canceled)

57. An automated, spatially-aware feature engineering method, comprising:
extracting geometric data from spatial data, the spatial data representing a plurality of spatial objects, the extracted geometric data characterizing one or more geometric elements of each of the spatial objects;
extracting location data from the spatial data, the extracted location data indicating one or more sets of coordinates of one or more locations associated with each of the spatial objects; generating a dataset comprising a plurality of spatial observations representing the respective plurality of spatial objects, wherein each spatial observation includes (1) a respective value of a location feature indicating a set of coordinates of a representative location of the spatial object corresponding to the spatial observation, and (2) respective values of one or more other features;
for each of the spatial observations,
deriving respective values of one or more solitary spatial features based on a portion of the extracted geometric data characterizing the geometric elements of the spatial object represented by the spatial observation, and
adding the values of the one or more solitary spatial features to the dataset; and
training one or more machine learning models by performing one or more machine learning processes on the dataset.

58-87. (canceled)
